(19) United States
(12) Patent Application Publication
(10) Pub. No.: US 2026/0290335 A1
(43) Pub. Date: Sep. 24, 2026

(54) SMART VOICE ASSISTANT

(71) Applicant: Volvo Car Corporation, Gothenburg (SE)

(72) Inventors: Casper Wickman, Öckerö (SE); Carl Bengt Martin Myhrman, Göteborg (SE)

(21) Appl. No.: 19/085,196

(22) Filed: Mar. 20, 2025

(51) Int. Cl. G10L 15/22; B60K 35/10; G06V 20/59; G10L 15/18

(52) U.S. Cl. CPC G10L 15/22; B60K 35/10; G06V 20/593; G10L 15/1822

(57) ABSTRACT

Techniques dynamic voice assistance for transportation vehicles are provided. In an example, a method comprises identifying, by a system onboard a vehicle comprising a processor, an at least one passenger inside the vehicle. The method can further comprise determining, by the system, a location of the at least one passenger within the vehicle. The method can further comprise determining, by the system, a current status of the vehicle. The method can further comprise identifying, by the system, speech of the at least one passenger. The method can further comprise analyzing, by the system, the speech to determine an intent of the at least one passenger. The method can further comprise regulating, by the system, one or more systems of the vehicle.

### TECHNICAL FIELD

The disclosed subject matter relates to vehicles (e.g., transportation vehicles), and more particularly, to vehicle-based voice assistant systems.

### BACKGROUND

Conventional in-car voice assistant systems are limited in their functionality and interaction capabilities. Current systems typically rely on simple command-based interfaces that require users to issue specific, predefined commands to control vehicle functions. These systems often require manual activation through either a dedicated button or a fixed activation statement. While conventional designs can allow for basic voice control, they generally fail to provide seamless, intuitive user experiences.

Reliance on predefined commands can restrict natural language communication, making it difficult for users to interact with in-car voice assistant systems in a conversational manner. Convention systems also fail to account for contextual information. This limitation can result in incorrect or suboptimal responses, particularly in shared vehicle environments where multiple passengers can issue requests.

Additionally, the presence of background noise, such as music, road noise, or conversations between passengers, can further hinder the effectiveness of conventional voice assistants. These systems often struggle to isolate and interpret user commands accurately in noisy environments, reducing their reliability. Furthermore, current systems typically lack advanced learning capabilities that enable them to improve their accuracy and responsiveness over time.

Given these shortcomings, there is a need for improved vehicle-based voice assistant systems.

### SUMMARY

The following presents a summary to provide a basic understanding of one or more embodiments of the invention. This summary is not intended to identify key or critical elements or delineate any scope of the particular embodiments or any scope of the claims. Its sole purpose is to present concepts in a simplified form as a prelude to the more detailed description that is presented later. In one or more embodiments described herein, systems, devices, computer-implemented methods, apparatuses and/or computer program products can facilitate dynamic voice assistance for transportation vehicles.

As alluded to above, improved techniques for vehicle-based voice assistant systems are desirable, and various embodiments are described herein to this end and/or other ends.

Through a combination of natural language processing (NLP), large language model (LLM) processing, contextual awareness, and adaptive learning capabilities, the herein described system can address the major limitations of conventional in-car voice assistants. By improving noise filtering, enabling hands-free interaction, and providing tailored responses based on passenger identity and location, the described system can offer a significant advancement in voice-based vehicle control. As a result, the described invention can enhance user convenience, improve driving safety, and create a more personalized and enjoyable in-car experience.

According to an embodiment, a system can comprise a memory that stores computer executable components, and a processor (e.g., a core computer) that executes the computer executable components stored in the memory, including a passenger identification component that identifies an at least one passenger inside the vehicle and determines a location of the at least one passenger within the vehicle. The computer executable components can further comprise a status component that determines a current status of the vehicle. The computer executable components can further comprise a voice recognition component that identifies speech of the at least one passenger within the vehicle and analyzes the speech to determine an intent of the at least one passenger. The computer executable components can further comprise a regulation component that, based at least on the identity of the at least one passenger, the location of the at least one passenger, the current status of the vehicle, or the determined intent of the at least one passenger, regulates one or more systems of the vehicle.

According to another embodiment, a method can comprise identifying, by a system onboard a vehicle comprising a processor (e.g., a core computer), an at least one passenger inside the vehicle. The method can further comprise determining, by the system, for example the processor of the system, a location of the at least one passenger within the vehicle. The method can further comprise determining, by the system, a current status of the vehicle. The method can further comprise identifying, by the system, speech of the at least one passenger. The method can further comprise analyzing, by the system, the speech to determine an intent of the at least one passenger. The method can further comprise regulating, by the system, based at least on the identity of the at least one passenger, the location of the at least one passenger, the current status of the vehicle, or the determined intent of the at least one passenger, one or more systems of the vehicle.

According to yet another embodiment, a non-transitory machine-readable medium can comprise executable instructions that, when executed by a processor (e.g., a core computer) integrated on or within a vehicle, facilitate performance of operations, comprising identifying an at least one passenger inside the vehicle; determining a location of the at least one passenger; determining a current status of the vehicle; identifying speech of the at least one passenger within the vehicle; analyzing the speech to determine an intent of the at least one passenger; and, based at least on the identity of the at least one passenger, the location of the at least one passenger, the current status of the vehicle, or the determined intent of the at least one passenger, regulating one or more systems of the vehicle.

### BRIEF DESCRIPTION OF DRAWINGS

FIGS. 1 and 2 illustrate block diagrams of exemplary voice assistant systems for vehicles, in accordance with one or more embodiments described herein.

FIGS. 3 and 4 illustrate flow diagrams of example, non-limiting computer implemented methods that can facilitate dynamic voice assistance for transportation vehicles in accordance with one or more embodiments described herein.

FIG. 5 illustrates a diagram of an example system architecture that can facilitate dynamic voice assistance for transportation vehicles in accordance with one or more embodiments described herein.

FIG. 6 is an example of a non-limiting computing environment in which one or more embodiments described herein can be implemented.

FIG. 7 is an example of a non-limiting networking environment in which one or more embodiments described herein can be implemented.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

As noted above, conventional in-car voice assistant systems are limited in their functionality and are often unable to provide a seamless and intuitive user experience. These systems typically rely on simple voice-based queries that activate a limited set of vehicle functions. In most cases, activating the voice assistant requires pressing a dedicated button or issuing a predefined activation statement. While this method can be functional, it limits the natural flow of interaction between the user and the system. Furthermore, these systems struggle to effectively recognize and distinguish between multiple passengers in the vehicle, leading to incorrect or suboptimal responses in shared driving environments.

A significant limitation of current in-car voice assistants is their inability to manage audio contamination. Modern vehicles frequently contain multiple competing sound sources such as music, road noise, air conditioning, or passenger conversations. These background sounds often interfere with the system’s ability to accurately detect and interpret voice commands. As a result, users may need to repeatedly issue commands or modify their speech patterns to achieve the desired outcome. This can create a frustrating and inefficient experience, particularly when urgent or safety-critical requests need to be understood.

A further shortcoming of existing systems is their inability to effectively personalize responses based on the identity and location of the speaker. Conventional systems generally treat all passengers equally, without distinguishing between the driver and other occupants. Consequently, commands such as “turn up the temperature” may apply changes to the entire cabin instead of targeting the relevant seating area. Similarly, requests for music, navigation, or vehicle settings may fail to align with the preferences of the intended user, limiting the system’s overall utility.

Furthermore, current systems often lack robust methods for improving user identification accuracy over time. While some systems may attempt to build basic user profiles, they generally do not utilize sophisticated learning models that refine identification based on historical data, environmental context, or behavioral patterns. This limitation restricts the system’s ability to tailor responses and improve accuracy with continued use.

The described invention can overcome the above-described limitations of existing systems by integrating advanced technologies such as natural language processing (NLP) and artificial intelligence (AI) based language models. The described system can significantly enhance the capabilities of in-car voice assistants by providing a more natural conversational interface that can operate effectively even in noisy environments. Through the use of specialized microphones with onboard digital processing, the described system can isolate speech signals from surrounding noise. This Voice Activity Detection (VAD) feature can assign a probability score to voice data samples, enhancing the system’s ability to determine when a user is speaking, even in challenging acoustic conditions.

The described system also introduces improved passenger identification methods that can utilize multiple data points to identify a speaker’s identity and location within the vehicle. By analyzing latency differences and decibel levels across multiple distributed microphones, the system can determine which passenger is speaking and where they are seated. This information can be crucial for responding to individualized requests, such as adjusting temperature zones or controlling personalized entertainment preferences.

To further improve user identification, the system can leverage a database of previously identified voice signatures. Each stored voice signature can be assigned a probability score that can reflect the system’s confidence in matching the detected voice to a known profile. This probability score can be calculated using mathematical models such as Bayesian inference, which can incorporate both prior probabilities and new data to assess the likelihood that a detected voice signature matches a particular user. For example, Bayesian inference can be used to update the probability score based on additional evidence, such as voice similarity metrics, recent interactions, or expected user behavior. The system can also reference additional contextual data, such as connected mobile devices, user profiles, or environmental information, to refine the probability score and improve identification accuracy. By continuously refining its database with new interactions, the system can systematically improve its ability to correctly identify passengers and deliver personalized responses.

The described system can integrate a large language model (LLM) to significantly expand its conversational capabilities. For example, when a passenger’s request does not align with predefined keywords, the entire speech string can be sent to an LLM for interpretation. This feature can allow the system to respond intelligently to complex, nuanced, or unexpected requests. The LLM can operate either on board the vehicle or in the cloud, ensuring flexibility in processing capabilities. Additionally, the system can allow users to bypass traditional activation methods by recognizing contextual cues. The described system can further improve convenience and safety by learning behavioral patterns and relationships between users. By combining contextual data with user identification, the system is capable of delivering highly personalized responses.

Through a combination of NLP, LLM processing, contextual awareness, and adaptive learning capabilities, the described system can address the major limitations of conventional in-car voice assistants. By improving noise filtering, enabling hands-free interaction, and providing tailored responses based on passenger identity and location, the described system can offer a significant advancement in voice-based vehicle control. As a result, the described invention can enhance user convenience, improve driving safety, and create a more personalized and enjoyable in-car experience.

In accordance with one or more embodiments, the disclosed solution provides a system for vehicles that facilitates dynamic voice assistance for transportation vehicles. In various embodiments, the onboard computer system of the vehicle can comprise a memory that stores computer-executable components, and a processor that executes the computer executable components stored in the memory. These computer-executable components can include a passenger identification component that identifies an at least one passenger inside the vehicle and determines a location of the at least one passenger within the vehicle. The computer executable components can further comprise a status component that determines a current status of the vehicle. The computer executable components can further comprise a voice recognition component that identifies speech of the at least one passenger within the vehicle and analyzes the speech to determine an intent of the at least one passenger. The computer executable components can further comprise a regulation component that, based at least on the identity of the at least one passenger, the location of the at least one passenger, the current status of the vehicle, or the determined intent of the at least one passenger, regulates one or more systems of the vehicle.

According to some embodiments, the passenger identification component can identify one or more passengers inside the vehicle and can determine the respective location of each identified passenger. This functionality can be achieved through a combination of advanced audio processing techniques, visual sensor analysis, and contextual data interpretation. By integrating multiple data sources, the passenger identification component can enhance accuracy in determining passenger identity and seating position, which can further improve the system’s ability to provide personalized responses and control vehicle functions appropriately.

In various embodiments, the passenger identification component can utilize multiple microphones distributed throughout the vehicle cabin to detect speech signals. These microphones can include acoustic echo cancellation microphones with onboard digital processing that can reduce background noise and isolate voice signals from competing sounds such as music, road noise, or conversations. By utilizing these enhanced microphones, the passenger identification component can effectively identify speech even in noisy environments. The system can apply Voice Activity Detection (VAD) techniques to determine when a passenger is speaking. VAD can assign a probability score to detected audio samples, indicating the likelihood that the sample contains active speech. For example, in a noisy environment where music is playing, the VAD process can identify a series of 200ms audio samples with varying probability percentages, enabling the system to focus only on relevant speech data.

In some embodiments, the passenger identification component can determine the location of the speaking passenger within the vehicle. The system can measure latency differences between multiple microphones and can analyze the decibel (dB) levels of the detected speech to calculate the position of the passenger. This capability can be critical for distinguishing between multiple occupants and ensuring that personalized commands are applied correctly. For example, if a second-row passenger requests to lower their window, the passenger identification component can determine the speaker’s position and activate the correct window. This feature can reduce errors commonly encountered in conventional systems that lack precise localization capabilities.

According to some embodiments, the passenger identification component can generate a unique voice signature for each identified passenger. A voice signature can be a set of unique acoustic features derived from a passenger’s speech patterns, pitch, and tone. Upon detecting a voice signature, the passenger identification component can reference the determined signature against a database of known or previously identified voices. Each stored voice signature can include a probability score ranging from 0 to 100%, indicating the system’s confidence in identifying the speaker. If the probability score exceeds a predetermined threshold, the system can confirm the speaker’s identity with a high degree of certainty. For instance, if a driver enters the vehicle and greets the system by saying, “It’s me, John,” the passenger identification component can analyze the voice signature and match it against stored profiles to activate John’s user preferences.

In various embodiments, if the system cannot confidently match a detected voice signature to any known profiles, the passenger identification component can transmit the voice signature to a user identification module for additional processing. The user identification module can enhance identification accuracy by cross-referencing other contextual data such as mobile device connectivity, vehicle entry patterns, and past interactions. For example, if a phone connected to the vehicle via Bluetooth corresponds to a known user profile, the system can increase the probability score of the corresponding voice signature. By dynamically refining probability scores based on multiple data points, the passenger identification component can systematically improve its accuracy over time.

The passenger identification component can also incorporate visual sensors, such as driver monitoring cameras or occupant monitoring cameras, to further enhance identification accuracy. Visual data can be analyzed to determine the presence and seating position of each passenger. This additional layer of identification can help to confirm the identity of a speaker, particularly in scenarios where voice data alone may be insufficient. For example, if a passenger states, “I’m cold,” the system can combine voice signature analysis with visual sensor data to confirm that the speaker is seated in the third-row seat and can adjust the temperature in that zone accordingly.

The passenger identification component can identify dynamic changes in the vehicle’s occupancy. The passenger identification component can determine when a passenger has entered or exited the vehicle, allowing the system to manage user profiles and environmental settings accordingly. For example, if a passenger known to prefer a cooler cabin environment enters the car, the system can automatically adjust the climate settings to align with that user’s preferences. Similarly, the system can detect when a passenger has changed seats and can adjust personalized settings such as audio balance, temperature control, or lighting to reflect the passenger’s new position.

The passenger identification component can enhance the functionality of a vehicle’s smart assistant by recognizing familial or social relationships between passengers. For example, if a child in the third-row seat asks, “Dad, when will we get there?” and a male voice responds from the driver’s seat, the system can infer the relationship and store this information in the database. Over time, this data can enable the system to respond more intelligently by understanding interpersonal dynamics, which can further improve the natural interaction experience.

The passenger identification component can reduce reliance on traditional voice assistant activation methods. By combining voice signature analysis, speaker location data, and contextual awareness, the system can automatically determine when a passenger is issuing a command, eliminating the need for activation statements or button presses. For instance, if music is playing loudly in the car and a child in the back says, “I need to use the restroom,” the passenger identification component can identify the speaker, recognize the request, and lower the music volume or communicate the message to the driver through targeted headrest speakers.

The passenger identification component can incorporate adaptive learning algorithms that improve identification accuracy over time. These algorithms can analyze patterns in passenger behavior, speech characteristics, and environmental conditions to refine user profiles and improve voice signature recognition. For example, if a passenger frequently adjusts the temperature in a particular zone or regularly requests specific music playlists, the system can learn these preferences and proactively adjust the vehicle’s environment in anticipation of future requests.

The passenger identification component can implement dynamic user profile management, allowing the system to automatically update and maintain individual profiles based on new interactions. For instance, if a passenger’s voice signature initially matches multiple profiles with low probability scores, the system can use additional contextual data, such as seating position or connected devices, to refine the match and increase the associated probability score. Over time, the system can increase confidence in the identified voice signature, reducing errors and improving personalization. Additionally, if a previously unidentified passenger repeatedly uses the system and interacts with specific vehicle functions, the passenger identification component can create a new profile for that passenger, which can improve accuracy in future interactions.

The passenger identification component can employ contextual awareness to improve its functionality. The system can consider various contextual factors, such as the vehicle’s speed, direction, or environmental conditions, when processing passenger commands. For example, if the system detects that the vehicle is traveling at highway speeds, it can prioritize urgent or safety-critical commands, such as navigation requests, over less immediate requests like music changes. Additionally, the passenger identification component can infer relationships between passengers to improve accuracy. For instance, if a child’s voice is detected alongside a known parent’s voice, the system can infer a familial relationship and prioritize relevant requests accordingly.

The passenger identification component can manage multiple simultaneous voice interactions. In shared vehicle environments where multiple passengers are speaking at once, the system can isolate and process individual voice streams by analyzing audio data from distributed microphones. This feature can enable the system to handle overlapping conversations, ensuring that each passenger’s request is accurately identified and addressed. For example, if a passenger in the third row requests a temperature increase while a front-row passenger requests navigation assistance, the system can accurately distinguish between these requests and execute the appropriate actions for each.

The passenger identification component can further incorporate enhanced privacy controls to protect sensitive user data. The system can implement encryption protocols to secure stored voice signatures and user profiles. Additionally, the system can allow vehicle owners or administrators to establish privacy preferences that restrict how passenger data is collected, stored, and shared. For example, a parent may choose to limit the system’s ability to store or analyze a child’s voice data to ensure privacy. The system can also allow users to manage their individual profiles by adding, deleting, or modifying stored data.

The passenger identification component can incorporate enhanced security features that ensure only authorized users can modify critical vehicle settings. For instance, the system can restrict the ability to change safety-related settings, such as disabling child locks or altering maximum speed limits, to verified users whose voice signatures have been authenticated. This feature can improve vehicle security by preventing unauthorized occupants from accessing certain vehicle functions. In addition to voice-based identification, the passenger identification component can utilize multi-factor identification to increase identification accuracy and security. This can include combining voice recognition with other data points such as facial recognition via vehicle cameras, mobile device connectivity, or biometric data. For example, if a passenger claims to be a specific user but the voice signature does not meet the required probability score, the system can reference a connected mobile device associated with that user to increase confidence in the identification.

The passenger identification component can also incorporate predictive modeling to anticipate user needs and proactively suggest relevant actions. By analyzing historical data, the system can predict common requests and provide timely responses without explicit commands. For example, if a driver regularly requests the same playlist when driving to work, the system can proactively start playing that playlist when the driver enters the vehicle during commuting hours. Similarly, if a user frequently requests navigation to a specific location after leaving work, the system can anticipate this behavior and suggest the destination as soon as the driver enters the car.

The passenger identification component can further improve vehicle comfort by dynamically adjusting environmental settings based on user preferences. For example, if the system identifies that a particular passenger prefers a warmer climate, it can automatically increase the temperature in that passenger’s zone when they are detected in the vehicle. Similarly, if a user frequently adjusts their seat position, the system can store this preference and automatically adjust the seat upon identifying that passenger’s voice signature.

The passenger identification component can also facilitate personalized communication between vehicle occupants. For example, if music is playing loudly in the car and a rear passenger attempts to speak to the driver, the system can identify the speaker’s location, lower the music volume in that area, or transmit the message to the driver through dedicated headrest speakers.

In some embodiments, the status component can determine a current status of the vehicle. The status component can provide contextual information that can improve the system’s ability to interpret user commands, regulate vehicle functions, and enhance passenger safety and convenience. The status component can analyze multiple data sources, including internal vehicle systems, environmental sensors, and external data feeds, to generate a comprehensive understanding of the vehicle’s current state.

The status component can determine whether the vehicle is in motion or stationary. By referencing vehicle speed data, the system can determine if the car is driving, parked, idling, or stopped in traffic. This information can be crucial in determining the appropriateness of certain commands. For example, if the driver requests to watch a video, the system can determine that the vehicle is in motion and reject the request for safety reasons. Conversely, if the system determines that the vehicle is parked, it can allow media content to play on the infotainment screen. The status component can also determine whether the vehicle is actively accelerating, decelerating, or stopped at a traffic light, allowing the system to prioritize certain functions depending on the vehicle's behavior.

The status component can detect environmental conditions that can impact vehicle operation. For example, the status component can determine whether the vehicle is driving in heavy rain, snow, or fog by referencing data from external sensors, windshield wiper usage, or traction control data. This information can improve the system’s ability to respond appropriately to user requests. For instance, if a passenger says, “It’s hard to see,” the status component can determine that the vehicle is driving in fog and automatically activate fog lights or increase dashboard brightness. Similarly, if the system determines that the vehicle is driving in icy conditions, the system can suggest reducing speed or activating additional safety features.

The status component can determine if the vehicle is located in a hazardous area, such as a construction zone, accident site, or near emergency vehicles. The system can reference GPS data, real-time traffic updates, or vehicle-to-infrastructure communication to identify these conditions. For example, if the system determines that the vehicle is approaching a construction zone, it can automatically lower the music volume to ensure the driver hears important instructions

or alerts. Similarly, if an emergency vehicle is detected nearby, the system can notify the driver and recommend pulling over to ensure safe passage.

The status component can determine if the vehicle has been involved in an accident or is experiencing a mechanical issue, electrical issue, and/or a software issue. By referencing data from airbag sensors, collision detection systems, or diagnostic error codes, the system can identify emergency situations and take appropriate action. For example, if the system detects that the airbags have deployed, the status component can automatically initiate a call to emergency services, provide GPS location data, and unlock the vehicle doors to assist first responders. Additionally, if the status component detects mechanical issues such as low tire pressure, overheating, or engine failure, it can provide alerts and suggest appropriate actions to resolve the issue.

The status component can reference road condition data to enhance vehicle safety and improve command interpretation. For example, if the system determines that the vehicle is driving on a winding mountain road, it can limit certain non-essential voice assistant functions to minimize driver distraction. Alternatively, if the system determines that the vehicle is in a congested urban area, it can prioritize navigation instructions, lane guidance, or pedestrian alerts to assist the driver.

The status component can determine the vehicle’s fuel or battery status, which can improve decision-making for travel-related requests. For example, if a passenger asks, “How long until we arrive?” the system can determine that the vehicle’s fuel is low and suggest a refueling stop along the route. Similarly, if the system determines that the vehicle is an electric vehicle with limited battery range, it can recommend charging stations based on the vehicle’s current location and route.

The status component can detect conditions that can affect vehicle accessibility. For example, the system can determine that the vehicle is parked on an incline, which may require additional brake pressure when exiting the vehicle. Similarly, if the system determines that the vehicle’s doors are obstructed, such as by a nearby wall or parked vehicle, it can adjust door opening angles to ensure safe entry and exit.

The status component can incorporate data from weather forecasting services, road condition reports, and other external data sources to improve situational awareness. For example, if the system determines that a snowstorm is approaching, it can recommend that the driver take an alternative route or delay travel. Similarly, if the system detects extreme heat conditions, it can automatically increase air conditioning levels to improve passenger comfort.

The status component can also assist with passenger requests that depend on vehicle conditions. For example, if a passenger asks, “Can I open my window?” the system can reference the vehicle’s speed and determine that the car is traveling at highway speeds, prompting the system to partially lower the window to prevent wind noise and maintain cabin comfort. In another example, if a child in the rear seat says, “I’m cold,” the system can determine the vehicle’s climate control status and adjust the rear temperature settings accordingly.

The status component can dynamically adapt its behavior based on changing vehicle conditions. For example, if the system determines that the vehicle is transitioning from city driving to highway driving, it can increase the volume of navigation instructions to ensure the driver hears key alerts. Similarly, if the system determines that the vehicle is approaching a toll booth, it can automatically lower the driver’s window to facilitate payment.

In some embodiments, the voice recognition component can identify speech of one or more passengers within the vehicle and can analyze the detected speech to determine the passenger’s intent. This functionality can be achieved using various audio processing techniques, speech analysis models, and artificial intelligence-driven language models. By leveraging these technologies, the voice recognition component can improve the system’s ability to interpret user requests accurately, even in complex or noisy environments.

The voice recognition component can utilize multiple microphones distributed throughout the vehicle to capture speech. These microphones can include acoustic echo cancellation technology to isolate voice data from background noise, such as music, road noise, or passenger conversations. The voice recognition component can apply Voice Activity Detection (VAD) to determine when a passenger is speaking. VAD can assign probability scores to short audio samples, helping the system distinguish between speech and background noise. For example, in a scenario where music is playing loudly in the cabin, the voice recognition component can use VAD to detect a brief command with high accuracy.

The voice recognition component can comprise a keyword spotting module that can identify specific key words in the detected speech. The keyword spotting module can analyze detected audio data to search for predefined keywords that are associated with particular vehicle functions. Upon detecting these keywords, the keyword spotting module can transmit the detected keywords to a function decision module, which can execute the corresponding action or determine the appropriate response. The keyword detection feature can allow the system to efficiently recognize common commands without requiring complex language analysis. The keyword spotting module can further improve its functionality by incorporating context-aware detection capabilities. For example, the module can prioritize certain keywords when the vehicle is in motion, ensuring that critical safety or navigation requests are detected quickly. Additionally, the keyword spotting module can dynamically adjust its keyword detection thresholds based on environmental conditions, such as increasing detection sensitivity in noisy environments to ensure passenger commands are identified effectively.

In addition to keyword detection, the voice recognition component can transmit speech data to a large language model for advanced analysis and interpretation. The LLM can provide sophisticated natural language processing capabilities that can enable the system to interpret complex, conversational requests. The LLM can also process multi-step commands, ambiguous language, and conversational phrasing that traditional keyword detection systems can struggle to interpret.

The voice recognition component can determine when to send speech data to the LLM based on keyword analysis, passenger preferences, or environmental conditions. For example, if the keyword spotting module fails to identify a relevant keyword, the system can automatically forward the entire speech string to the LLM for interpretation. Additionally, if a passenger uses conversational language, the voice recognition component can determine that the LLM is better suited to process the request and forward the corresponding audio data accordingly.

The LLM can operate onboard the vehicle or in the cloud. When operating in the cloud, the system can leverage cloud computing resources to process more complex queries with enhanced accuracy. Alternatively, when cloud connectivity is limited or unavailable, the system can utilize an onboard LLM to ensure continuous functionality. The voice recognition component can intelligently select the most appropriate processing method based on network availability, response time requirements, and the complexity of the detected speech.

The voice recognition component can further improve accuracy and efficiency by combining speech analysis with contextual data. The voice recognition component can improve system security by implementing user-specific voice identification features. By referencing the passenger identification component’s voice signature database, the voice recognition component can determine the identity of the speaker and adjust permissions accordingly. In some embodiments, the voice recognition component can prioritize specific passenger voices over others based on user profiles or seating position. The voice recognition component can facilitate conversational interactions that allow users to refine their requests naturally.

In various embodiments, the regulation component can regulate one or more systems of the vehicle. The regulation component can regulate one or more vehicle systems based on various contextual factors, including the identity of the passenger, the location of the passenger, the current status of the vehicle, and the determined intent of the passenger. The regulation component can combine these inputs to determine the most appropriate response to passenger requests, environmental conditions, and vehicle operation requirements. By integrating data from multiple system components, the regulation component can improve the vehicle’s responsiveness, enhance passenger comfort, and increase overall safety.

The regulation component can receive input from the passenger identification component to determine which passenger issued a request and where that passenger is located within the vehicle. This information can allow the regulation component to apply changes only in the relevant zone or for the appropriate user.

The regulation component can use input from the voice recognition component to determine the intent of a passenger’s speech. The regulation component can analyze detected keywords or interpret natural language responses provided by a large language model to determine the appropriate action. The regulation component can further modify a response based on vehicle status data, ensuring that the requested function is performed in a safe and appropriate manner.

The regulation component can regulate vehicle systems in response to commands that involve complex or multi-step requests. The regulation component can use data from the passenger identification component to determine a relevant control zone and an appropriate seat adjustments based on passenger location. The regulation component can use vehicle status data to determine whether certain actions should be permitted, restricted, or modified based on safety considerations.

The regulation component can dynamically adapt vehicle settings in response to environmental conditions. The regulation component can personalize vehicle settings based on stored user profiles. The regulation component can manage media and communication functions to improve the in-car experience. The regulation component can improve vehicle security by enforcing authorization requirements for certain commands. For example, if a child seated in the second row requests to unlock the doors while the vehicle is in motion, the regulation component can reject the request unless the identified speaker is an authorized adult. Similarly, the regulation component can require driver verification before enabling potentially dangerous commands, such as disabling driver assistance systems or altering safety settings. The regulation component can also regulate vehicle systems in response to predictive modeling and learned behaviors. The regulation component can also optimize responses by combining multiple data sources to provide contextually appropriate actions.

In some embodiments, the computer-executable components can include an artificial intelligence component. The artificial intelligence component can train an artificial intelligence model to identify a passenger inside the vehicle.

The artificial intelligence component can train an artificial intelligence system to identify one or more passengers inside the vehicle and can further train the AI system to determine in which seat each identified passenger is sitting. This functionality can be achieved through a combination of supervised learning, unsupervised learning, and reinforcement learning techniques. By continuously refining its recognition models through data collection and analysis, the artificial intelligence component can improve the system’s accuracy, adaptability, and responsiveness over time. The artificial intelligence component can train the AI system to identify passengers using a variety of data inputs. These data inputs can include voice data, visual data from occupant monitoring cameras, motion sensor data, and contextual information such as seating position and connected devices. The artificial intelligence component can combine these data points to build comprehensive models that identify individual passengers with increased reliability. The artificial intelligence component can improve identification accuracy by training the AI system to recognize voice signatures. The AI system can be trained to analyze key acoustic characteristics such as pitch, tone, speech rhythm, and vocal patterns to generate a unique voice signature for each passenger. By combining this voice data with seating position information obtained through distributed microphones, the artificial intelligence component can train the AI system to accurately associate voice profiles with individual seating positions. The artificial intelligence component can train the AI system to utilize visual data to improve passenger identification. For example, the system can analyze visual data from occupant monitoring cameras to identify distinguishing features such as facial structure, hair color, or clothing. The artificial intelligence component can combine this visual data with voice analysis to improve passenger identification accuracy.

The artificial intelligence component can train the AI system to identify passenger location within the vehicle. By analyzing latency differences and audio intensity from multiple microphones, the AI system can be trained to determine the exact seating position of a speaking passenger. The AI system can correlate audio latency patterns with seating positions, allowing it to develop increasingly accurate localization capabilities.

The artificial intelligence component can incorporate adaptive learning techniques to continuously improve system accuracy. The artificial intelligence component can analyze past interactions, passenger behavior patterns, and environmental conditions to refine its recognition models. The artificial intelligence component can train the AI system to predict passenger identity based on behavioral patterns and environmental cues. The artificial intelligence component can train the AI system to recognize familial or social relationships among passengers to improve contextual decision-making. The artificial intelligence component can train the AI system to resolve ambiguous or conflicting data.

The artificial intelligence component can be configured to address scenarios involving shared vehicle services, such as rental cars, carpooling systems, or taxis. In such environments, the artificial intelligence component can dynamically adjust system permissions and access levels based on a detected passenger’s identity and role. For example, the AI system can identify the driver as an authorized user with full access to vehicle controls, including navigation, safety features, and system settings. Conversely, passengers who are identified as temporary users, unknown individuals, or ride-share passengers can be restricted to limited functions such as adjusting rear temperature settings, controlling rear entertainment systems, or requesting music playback.

The artificial intelligence component can further enhance security in shared vehicle environments by applying tiered access permissions based on detected profiles. For example, the system can restrict passengers from issuing commands that impact vehicle safety, such as adjusting navigation routes or disabling driver assistance systems. If the system detects an unidentified individual attempting to perform restricted actions, it can require verification from an authorized user before proceeding.

The artificial intelligence component can improve system security by training the AI system to recognize unauthorized or unknown individuals. If the system detects a voice signature or visual profile that does not match any stored profiles, the artificial intelligence component can train the AI system to treat that individual as unverified. In such cases, the system can restrict access to certain vehicle functions or require additional authentication before executing certain commands.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

It will be understood that when an element is referred to as being “coupled” to another element, it can describe one or more different types of coupling including, but not limited to, chemical coupling, communicative coupling, capacitive coupling, electrical coupling, electromagnetic coupling, inductive coupling, operative coupling, conductive coupling, acoustic coupling, ultrasound coupling, optical coupling, physical coupling, thermal coupling, and/or another type of coupling. As referenced herein, an “entity” can comprise a human, a client, a user, a computing device, a software application, an agent, a machine learning model, an artificial intelligence, and/or another entity. It should be appreciated that such an entity can facilitate implementation of the subject disclosure in accordance with one or more embodiments described herein.

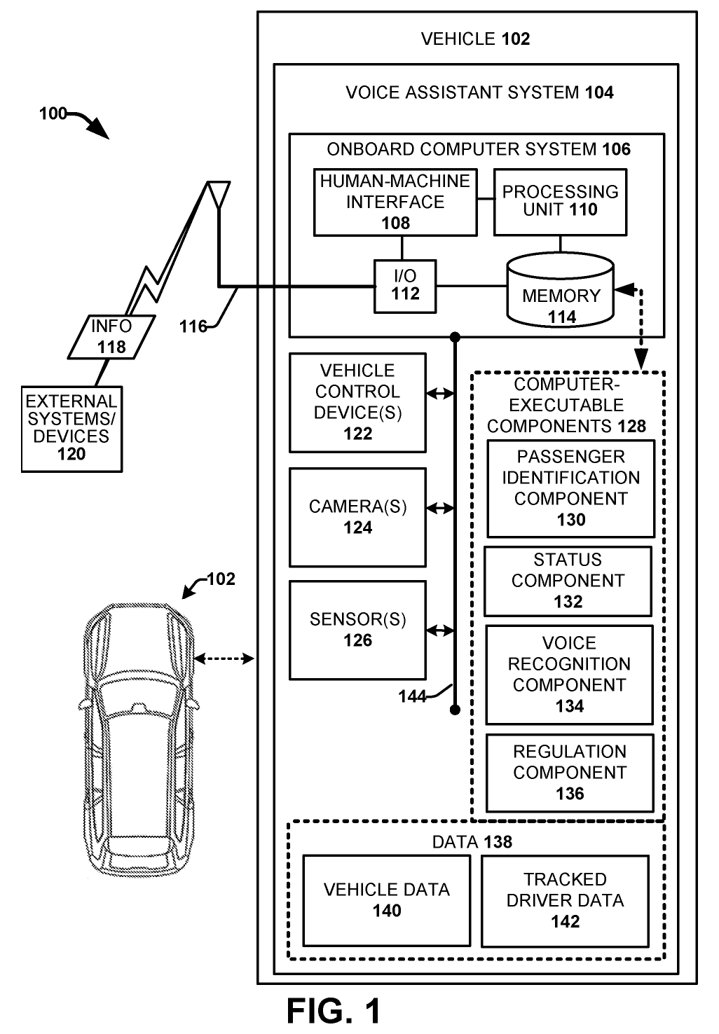

Turning now to the drawings, FIG. 1 illustrates a block diagram of an exemplary system 100 that facilitates dynamic voice assistance for transportation vehicles. System 100 includes a vehicle 102 comprising a voice assistant system 104 integrated thereon or therein. The voice assistant system 104 includes one or more vehicle control devices 122, one or more cameras 124, one or more sensors 126 and an onboard computer system 106. The onboard computer system 106 comprises at least one memory 114 that stores computer-executable components 128 and data 138 that can facilitate dynamic voice assistance onboard vehicle 102. These computer-executable components include (but are not limited to) passenger identification component 130, status component 132, voice recognition component 134, and regulation component 136.

The onboard computer system 106 includes at least one processor or processing unit 110 that executes the computer-executable component 128 stored in memory 114 to carry out the operations/functions described with respect to the corresponding computer-executable components.

Processor 110 can be a core computer of the vehicle 102. A core computer of a vehicle can refer to a central processing system that integrates, manages, and coordinates various electronic and computational functions within a vehicle. A core computer can serve as a primary hub for processing data and executing commands across multiple subsystems, including engine control, transmission, braking, steering, infotainment, advanced driver-assistance systems (ADAS), and connectivity features. A core computer can include a high-performance processor or system-on-chip (SoC) capable of handling real-time data processing, decision-making, and communication tasks, and can interface with sensors, actuators, and control modules distributed throughout a vehicle, thereby ensuring seamless operation and communication between different components. For example, in vehicles with autonomous or semi-autonomous capabilities, a core computer can process inputs from cameras, LiDAR, radar, and GPS to make real-time driving decisions. Processor 110 can further constitute a cloud-based or remote server integrated in a vehicle’s onboard systems and operationally connected to an external computing infrastructure. Vehicle 102 can be equipped with sensors 126 (such as cameras, LiDAR, radar, and GPS) that can gather real-time data about an environment and internal systems. Raw or pre-processed data from the sensors 126 can be transmitted to remote servers or cloud systems. Results can then be sent back to the vehicle 102 to inform decision-making or optimize performance.

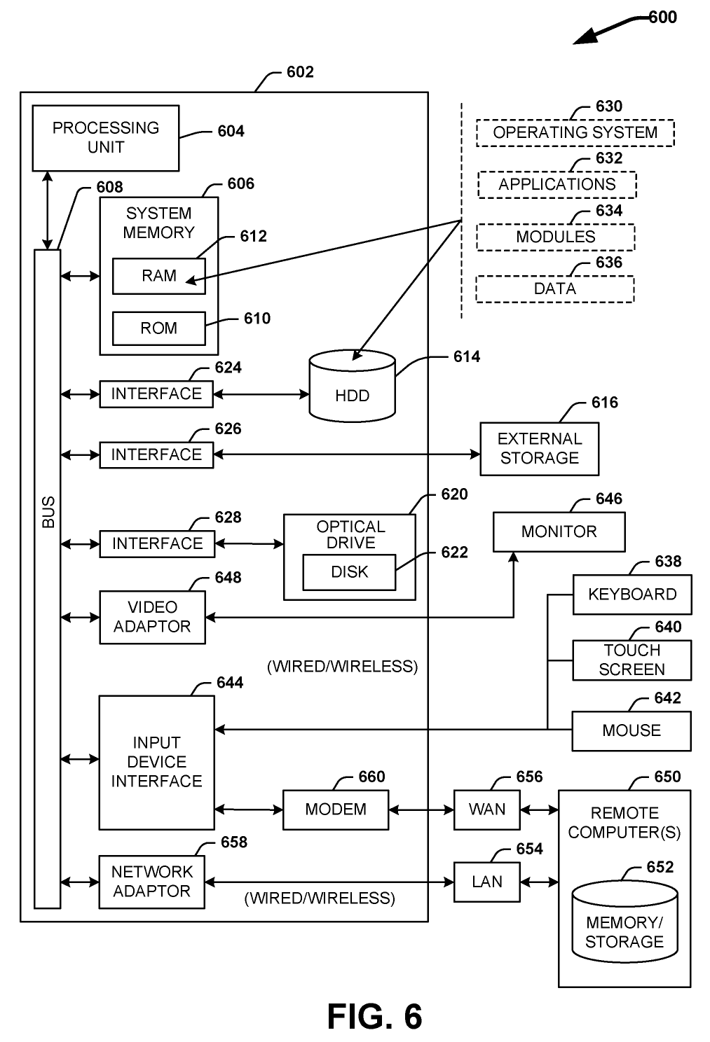

Examples of said memory 114, processing unit 110, and other computer system components that can be included in the onboard computer system 106 to facilitate the various features and functionalities of system 100 can be found with reference to FIG. 6 (e.g., system memory 606, processing unit 604, and the like).

The onboard computer system 106 can further include an input/output (I/O) component 112, wherein the I/O component 112 can be a transceiver configured to enable transmission/receipt of information 118 between the onboard computer system 106 and various external systems or devices 120. For example, the external systems or devices 120 can correspond to any type of device or computing system configured to wirelessly communicate (e.g., using radio frequency signals) with the onboard computer system 106, such as but not limited to, a mobile device associated with one or more users of the vehicle 102 (e.g., a smartphone, a smartwatch, a tablet, eyewear, a wearable headset or another type of wearable device), an external computer, an external computer system, an external application server, another vehicle’s onboard computer system, and so on. The I/O component 112 can be communicatively coupled, via an antenna 116, to the remotely located devices and systems (e.g., external systems/devices 120). Any suitable technology can be utilized to enable the various embodiments presented herein, regarding transmission and receiving of information 118 between the onboard computer system 106 and one or more external systems/devices 120. Suitable technologies include BLUETOOTH®, cellular technology (e.g., 3G, 4G, 5G), internet technology, ethernet technology, ultra-wideband (UWB), DECAWAVE®, IEEE 802.15.4a standard-based technology, Wi-Fi technology, Radio Frequency Identification (RFID), Near Field Communication (NFC) radio technology, and the like.

The onboard computer system 106 can also include a human-machine interface 108 that provides for receiving user input in association with utilizing the various features and functionalities of the computer-executable component 128 and presenting information to users. For example, the human-machine interfaces 108 can include or correspond to any suitable output device such as a display, a speaker, etc. and any suitable input device, such as a touchscreen display, a microphone, a keypad, a keyboard, a camera, a gesture input device/system, a voice input device/system, and the like. Examples of suitable input and output devices of the human-machine interface 108 devices are further provided with reference to FIG. 6. The voice assisrtant system 104 also include a system bus 144 that communicatively and operatively couples the onboard computer system 106, the one or more vehicle control device 122, the one or more cameras 124 and the one or more sensors 126 to one another using any suitable wired or wireless communication technology.

Vehicle 102 can correspond to any suitable type of transportation vehicle comprising one or more windows and adapted for use in scenarios in which monitoring the external environment is important, such as varying weather conditions or navigation in complex environments. For instance, vehicle 102 can include or correspond to any suitable type of motor vehicle (e.g., a car, a truck, a van, a sport utility vehicle (SUV), etc.). In some implementations vehicle 102 can also include or correspond to an aircraft (e.g., an airplane, a helicopter, or the like), a watercraft, or another type of passenger transportation vehicle. In some embodiments, vehicle 102 can include or correspond to an autonomous vehicle that is capable of navigating and operating without (or some) human input.

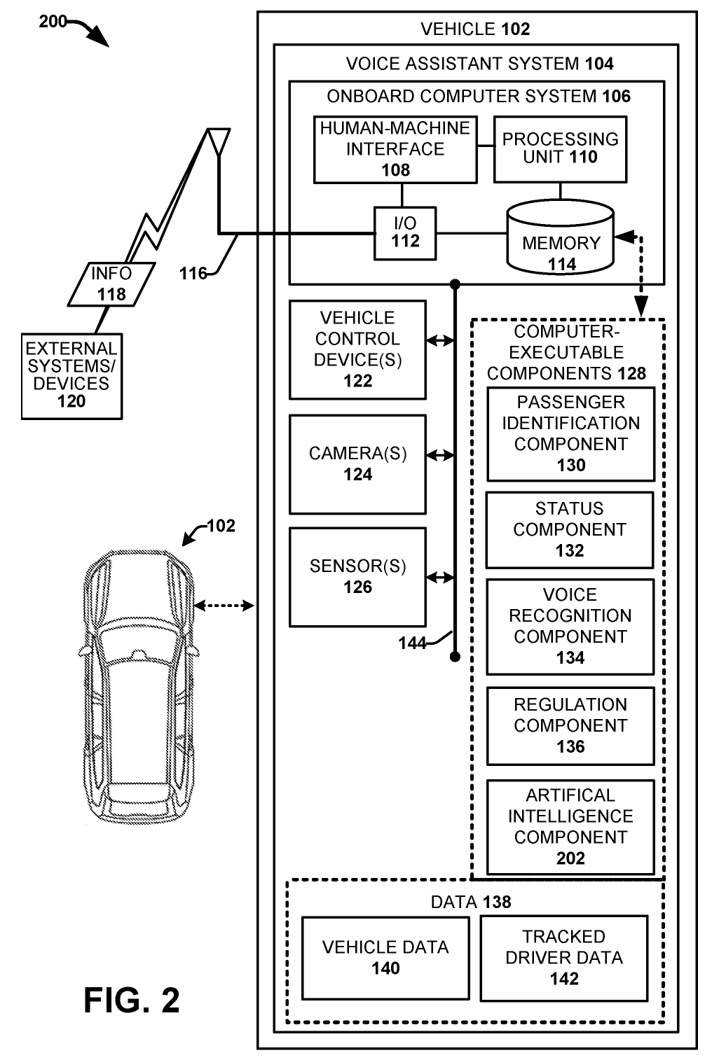

FIG. 2 illustrates an example system 200 that can facilitate dynamic voice assistance for vehicle 102. System 200 includes a vehicle 102 comprising a voice assistant system 104 integrated thereon or therein. The voice assistant system 104 includes one or more vehicle control device 122, one or more cameras 124, one or more sensors 126 and an onboard computer system 106. The onboard computer system 106 comprises at least one memory 114 that stores computer-executable components 128 and data 138 that facilitate dynamic voice assistance onboard vehicle 102. System 200 includes computer-executable components (but are not limited to) passenger identification component 130, status component 132, voice recognition component 134, regulation component 136 and artificial intelligence component 202.

According to some embodiments, the passenger identification component 130 can identify one or more passengers inside the vehicle and can determine the respective location of each identified passenger. This functionality can be achieved through a combination of advanced audio processing techniques, visual sensor analysis, and contextual data interpretation. By integrating multiple data sources, the passenger identification component 130 can enhance accuracy in determining passenger identity and seating position, which can further improve the system’s ability to provide personalized responses and control vehicle functions appropriately.

In various embodiments, the passenger identification component 130 can utilize multiple microphones distributed throughout the vehicle cabin to detect speech signals. These microphones can include acoustic echo cancellation microphones with onboard digital processing that can reduce background noise and isolate voice signals from competing sounds such as music, road noise, or conversations. By utilizing these enhanced microphones, the passenger identification component 130 can effectively identify speech even in noisy environments. The system can apply Voice Activity Detection (VAD) techniques to determine when a passenger is speaking. VAD can assign a probability score to detected audio samples, indicating the likelihood that the sample contains active speech. For example, in a noisy environment where music is playing, the VAD process can identify a series of 200ms audio samples with varying probability percentages, enabling the system to focus only on relevant speech data.

In some embodiments, the passenger identification component 130 can determine the location of the speaking passenger within the vehicle. The system can measure latency differences between multiple microphones and can analyze the decibel (dB) levels of the detected speech to calculate the position of the passenger. This capability can be critical for distinguishing between multiple occupants and ensuring that personalized commands are applied correctly. For example, if a second-row passenger requests to lower their window, the passenger identification component 130 can determine the speaker’s position and activate the correct window. This feature can reduce errors commonly encountered in conventional systems that lack precise localization capabilities.

According to some embodiments, the passenger identification component 130 can generate a unique voice signature for each identified passenger. A voice signature can be a set of unique acoustic features derived from a passenger’s speech patterns, pitch, and tone. Upon detecting a voice signature, the passenger identification component 130 can reference the determined signature against a database of known or previously identified voices. Each stored voice signature can include a probability score ranging from 0 to 100%, indicating the system’s confidence in identifying the speaker. If the probability score exceeds a predetermined threshold, the system can confirm the speaker’s identity with a high degree of certainty. For instance, if a driver enters the vehicle and greets the system by saying, “It’s me, John,” the passenger identification component 130 can analyze the voice signature and match it against stored profiles to activate John’s user preferences.

In various embodiments, if the system cannot confidently match a detected voice signature to any known profiles, the passenger identification component 130 can transmit the voice signature to a user identification module for additional processing. The user identification module can enhance identification accuracy by cross-referencing other contextual data such as mobile device connectivity, vehicle entry patterns, and past interactions. For example, if a phone connected to the vehicle via Bluetooth corresponds to a known user profile, the system can increase the probability score of the corresponding voice signature. By dynamically refining probability scores based on multiple data points, the passenger identification component 130 can systematically improve its accuracy over time.

The passenger identification component 130 can also incorporate visual sensors, such as driver monitoring cameras or occupant monitoring cameras, to further enhance identification accuracy. Visual data can be analyzed to determine the presence and seating position of each passenger. This additional layer of identification can help to confirm the identity of a speaker, particularly in scenarios where voice data alone may be insufficient. For example, if a passenger states, “I’m cold,” the system can combine voice signature analysis with visual sensor data to confirm that the speaker is seated in the third-row seat and can adjust the temperature in that zone accordingly.

The passenger identification component 130 can identify dynamic changes in the vehicle’s occupancy. The passenger identification component 130 can determine when a passenger has entered or exited the vehicle, allowing the system to manage user profiles and environmental settings accordingly. For example, if a passenger known to prefer a cooler cabin environment enters the car, the system can automatically adjust the climate settings to align with that user’s preferences. Similarly, the system can detect when a passenger has changed seats and can adjust personalized settings such as audio balance, temperature control, or lighting to reflect the passenger’s new position.

The passenger identification component 130 can enhance the functionality of a vehicle’s smart assistant by recognizing familial or social relationships between passengers. For example, if a child in the third-row seat asks, “Dad, when will we get there?” and a male voice responds from the driver’s seat, the system can infer the relationship and store this information in the database. Over time, this data can enable the system to respond more intelligently by understanding interpersonal dynamics, which can further improve the natural interaction experience.

The passenger identification component 130 can reduce reliance on traditional voice assistant activation methods. By combining voice signature analysis, speaker location data, and contextual awareness, the system can automatically determine when a passenger is issuing a command, eliminating the need for activation statements or button presses. For instance, if music is playing loudly in the car and a child in the back says, “I need to use the restroom,” the passenger identification component 130 can identify the speaker, recognize the request, and lower the music volume or communicate the message to the driver through targeted headrest speakers.

The passenger identification component 130 can incorporate adaptive learning algorithms that improve identification accuracy over time. These algorithms can analyze patterns in passenger behavior, speech characteristics, and environmental conditions to refine user profiles and improve voice signature recognition. For example, if a passenger frequently adjusts the temperature in a particular zone or regularly requests specific music playlists, the system can learn these preferences and proactively adjust the vehicle’s environment in anticipation of future requests.

The passenger identification component 130 can implement dynamic user profile management, allowing the system to automatically update and maintain individual profiles based on new interactions. For instance, if a passenger’s voice signature initially matches multiple profiles with low probability scores, the system can use additional contextual data, such as seating position or connected devices, to refine the match and increase the associated probability score. Over time, the system can increase confidence in the identified voice signature, reducing errors and improving personalization. Additionally, if a previously unidentified passenger repeatedly uses the system and interacts with specific vehicle functions, the passenger identification component 130 can create a new profile for that passenger, which can improve accuracy in future interactions.

The passenger identification component 130 can employ contextual awareness to improve its functionality. The system can consider various contextual factors, such as the vehicle’s speed, direction, or environmental conditions, when processing passenger commands. For example, if the system detects that the vehicle is traveling at highway speeds, it can prioritize urgent or safety-critical commands, such as navigation requests, over less immediate requests like music changes. Additionally, the passenger identification component 130 can infer relationships between passengers to improve accuracy. For instance, if a child’s voice is detected alongside a known parent’s voice, the system can infer a familial relationship and prioritize relevant requests accordingly.

The passenger identification component 130 can manage multiple simultaneous voice interactions. In shared vehicle environments where multiple passengers are speaking at once, the system can isolate and process individual voice streams by analyzing audio data from distributed microphones. This feature can enable the system to handle overlapping conversations, ensuring that each passenger’s request is accurately identified and addressed. For example, if a passenger in the third row requests a temperature increase while a front-row passenger requests navigation assistance, the system can accurately distinguish between these requests and execute the appropriate actions for each.

The passenger identification component 130 can further incorporate enhanced privacy controls to protect sensitive user data. The system can implement encryption protocols to secure stored voice signatures and user profiles. Additionally, the system can allow vehicle owners or administrators to establish privacy preferences that restrict how passenger data is collected, stored, and shared. For example, a parent may choose to limit the system’s ability to store or analyze a child’s voice data to ensure privacy. The system can also allow users to manage their individual profiles by adding, deleting, or modifying stored data.

The passenger identification component 130 can incorporate enhanced security features that ensure only authorized users can modify critical vehicle settings. For instance, the system can restrict the ability to change safety-related settings, such as disabling child locks or altering maximum speed limits, to verified users whose voice signatures have been authenticated. This feature can improve vehicle security by preventing unauthorized occupants from accessing certain vehicle functions. In addition to voice-based identification, the passenger identification component 130 can utilize multi-factor identification to increase identification accuracy and security. This can include combining voice recognition with other data points such as facial recognition via vehicle cameras, mobile device connectivity, or biometric data. For example, if a passenger claims to be a specific user but the voice signature does not meet the required probability score, the system can reference a connected mobile device associated with that user to increase confidence in the identification.

The passenger identification component 130 can also incorporate predictive modeling to anticipate user needs and proactively suggest relevant actions. By analyzing historical data, the system can predict common requests and provide timely responses without explicit commands. For example, if a driver regularly requests the same playlist when driving to work, the system can proactively start playing that playlist when the driver enters the vehicle during commuting hours. Similarly, if a user frequently requests navigation to a specific location after leaving work, the system can anticipate this behavior and suggest the destination as soon as the driver enters the car.

The passenger identification component 130 can further improve vehicle comfort by dynamically adjusting environmental settings based on user preferences. For example, if the system identifies that a particular passenger prefers a warmer climate, it can automatically increase the temperature in that passenger’s zone when they are detected in the vehicle. Similarly, if a user frequently adjusts their seat position, the system can store this preference and automatically adjust the seat upon identifying that passenger’s voice signature.

The passenger identification component 130 can also facilitate personalized communication between vehicle occupants. For example, if music is playing loudly in the car and a rear passenger attempts to speak to the driver, the system can identify the speaker’s location, lower the music volume in that area, or transmit the message to the driver through dedicated headrest speakers.

In some embodiments, the status component 132 can determine a current status of the vehicle. The status component 132 can provide contextual information that can improve the system’s ability to interpret user commands, regulate vehicle functions, and enhance passenger safety and convenience. The status component 132 can analyze multiple data sources, including internal vehicle systems, environmental sensors, and external data feeds, to generate a comprehensive understanding of the vehicle’s current state.

The status component 132 can determine whether the vehicle is in motion or stationary. By referencing vehicle speed data, the system can determine if the car is driving, parked, idling, or stopped in traffic. This information can be crucial in determining the appropriateness of certain commands. For example, if the driver requests to watch a video, the system can determine that the vehicle is in motion and reject the request for safety reasons. Conversely, if the system determines that the vehicle is parked, it can allow media content to play on the infotainment screen. The status component 132 can also determine whether the vehicle is actively accelerating, decelerating, or stopped at a traffic light, allowing the system to prioritize certain functions depending on the vehicle's behavior.

The status component 132 can detect environmental conditions that can impact vehicle operation. For example, the status component 132 can determine whether the vehicle is driving in heavy rain, snow, or fog by referencing data from external sensors, windshield wiper usage, or traction control data. This information can improve the system’s ability to respond appropriately to user requests. For instance, if a passenger says, “It’s hard to see,” the status component 132 can determine that the vehicle is driving in fog and automatically activate fog lights or increase dashboard brightness. Similarly, if the system determines that the vehicle is driving in icy conditions, the system can suggest reducing speed or activating additional safety features.

The status component 132 can determine if the vehicle is located in a hazardous area, such as a construction zone, accident site, or near emergency vehicles. The system can reference GPS data, real-time traffic updates, or vehicle-to-infrastructure communication to identify these conditions. For example, if the system determines that the vehicle is approaching a construction zone, it can automatically lower the music volume to ensure the driver hears important instructions or alerts. Similarly, if an emergency vehicle is detected nearby, the system can notify the driver and recommend pulling over to ensure safe passage.

The status component 132 can determine if the vehicle has been involved in an accident or is experiencing a mechanical issue. By referencing data from airbag sensors, collision detection systems, or diagnostic error codes, the system can identify emergency situations and take appropriate action. For example, if the system detects that the airbags have deployed, the status component 132 can automatically initiate a call to emergency services, provide GPS location data, and unlock the vehicle doors to assist first responders. Additionally, if the status component 132 detects mechanical issues such as low tire pressure, overheating, or engine failure, it can provide alerts and suggest appropriate actions to resolve the issue.

The status component 132 can reference road condition data to enhance vehicle safety and improve command interpretation. For example, if the system determines that the vehicle is driving on a winding mountain road, it can limit certain non-essential voice assistant functions to minimize driver distraction. Alternatively, if the system determines that the vehicle is in a congested urban area, it can prioritize navigation instructions, lane guidance, or pedestrian alerts to assist the driver.

The status component 132 can determine the vehicle’s fuel or battery status, which can improve decision-making for travel-related requests. For example, if a passenger asks, “How long until we arrive?” the system can determine that the vehicle’s fuel is low and suggest a refueling stop along the route. Similarly, if the system determines that the vehicle is an electric vehicle with limited battery range, it can recommend charging stations based on the vehicle’s current location and route.

The status component 132 can detect conditions that can affect vehicle accessibility. For example, the system can determine that the vehicle is parked on an incline, which may require additional brake pressure when exiting the vehicle. Similarly, if the system determines that the vehicle’s doors are obstructed, such as by a nearby wall or parked vehicle, it can adjust door opening angles to ensure safe entry and exit.

The status component 132 can incorporate data from weather forecasting services, road condition reports, and other external data sources to improve situational awareness. For example, if the system determines that a snowstorm is approaching, it can recommend that the driver take an alternative route or delay travel. Similarly, if the system detects extreme heat conditions, it can automatically increase air conditioning levels to improve passenger comfort.

The status component 132 can also assist with passenger requests that depend on vehicle conditions. For example, if a passenger asks, “Can I open my window?” the system can reference the vehicle’s speed and determine that the car is traveling at highway speeds, prompting the system to partially lower the window to prevent wind noise and maintain cabin comfort. In another example, if a child in the rear seat says, “I’m cold,” the system can determine the vehicle’s climate control status and adjust the rear temperature settings accordingly.

The status component 132 can dynamically adapt its behavior based on changing vehicle conditions. For example, if the system determines that the vehicle is transitioning from city driving to highway driving, it can increase the volume of navigation instructions to ensure the driver hears key alerts. Similarly, if the system determines that the vehicle is approaching a toll booth, it can automatically lower the driver’s window to facilitate payment.

In some embodiments, the voice recognition component 134 can identify speech of one or more passengers within the vehicle and can analyze the detected speech to determine the passenger’s intent. This functionality can be achieved using various audio processing techniques, speech analysis models, and artificial intelligence-driven language models. By leveraging these technologies, the voice recognition component 134 can improve the system’s ability to interpret user requests accurately, even in complex or noisy environments.

The voice recognition component 134 can utilize multiple microphones distributed throughout the vehicle to capture speech. These microphones can include acoustic echo cancellation technology to isolate voice data from background noise, such as music, road noise, or passenger conversations. The voice recognition component 134 can apply Voice Activity Detection (VAD) to determine when a passenger is speaking. VAD can assign probability scores to short audio samples, helping the system distinguish between speech and background noise. For example, in a scenario where music is playing loudly in the cabin, the voice recognition component 134 can use VAD to detect a brief command with high accuracy.

The voice recognition component 134 can comprise a keyword spotting module that can identify specific key words in the detected speech. The keyword spotting module can analyze detected audio data to search for predefined keywords that are associated with particular vehicle functions. Upon detecting these keywords, the keyword spotting module can transmit the detected keywords to a function decision module, which can execute the corresponding action or determine the appropriate response. The keyword detection feature can allow the system to efficiently recognize common commands without requiring complex language analysis. The keyword spotting module can further improve its functionality by incorporating context-aware detection capabilities. For example, the module can prioritize certain keywords when the vehicle is in motion, ensuring that critical safety or navigation requests are detected quickly. Additionally, the keyword spotting module can dynamically adjust its keyword detection thresholds based on environmental conditions, such as increasing detection sensitivity in noisy environments to ensure passenger commands are identified effectively.

In addition to keyword detection, the voice recognition component 134 can transmit speech data to a large language model for advanced analysis and interpretation. The LLM can provide sophisticated natural language processing capabilities that can enable the system to interpret complex, conversational requests. The LLM can also process multi-step commands, ambiguous language, and conversational phrasing that traditional keyword detection systems can struggle to interpret.

The voice recognition component 134 can determine when to send speech data to the LLM based on keyword analysis, passenger preferences, or environmental conditions. For example, if the keyword spotting module fails to identify a relevant keyword, the system can automatically forward the entire speech string to the LLM for interpretation. Additionally, if a passenger uses conversational language, the voice recognition component 134 can determine that the LLM is better suited to process the request and forward the corresponding audio data accordingly.

The LLM can operate onboard the vehicle or in the cloud. When operating in the cloud, the system can leverage cloud computing resources to process more complex queries with enhanced accuracy. Alternatively, when cloud connectivity is limited or unavailable, the system can utilize an onboard LLM to ensure continuous functionality. The voice recognition component 134 can intelligently select the most appropriate processing method based on network availability, response time requirements, and the complexity of the detected speech.

The voice recognition component 134 can further improve accuracy and efficiency by combining speech analysis with contextual data. The voice recognition component 134 can improve system security by implementing user-specific voice identification features. By referencing the passenger identification component’s voice signature database, the voice recognition component 134 can determine the identity of the speaker and adjust permissions accordingly. In some embodiments, the voice recognition component 134 can prioritize specific passenger voices over others based on user profiles or seating position. The voice recognition component 134 can facilitate conversational interactions that allow users to refine their requests naturally.

In various embodiments, the regulation component 136 can regulate one or more systems of the vehicle. The regulation component 136 can regulate one or more vehicle systems based on various contextual factors, including the identity of the passenger, the location of the passenger, the current status of the vehicle, and the determined intent of the passenger. The regulation component 136 can combine these inputs to determine the most appropriate response to passenger requests, environmental conditions, and vehicle operation requirements. By integrating data from multiple system components, the regulation component 136 can improve the vehicle’s responsiveness, enhance passenger comfort, and increase overall safety.

The regulation component 136 can receive input from the passenger identification component 130 to determine which passenger issued a request and where that passenger is located within the vehicle. This information can allow the regulation component 136 to apply changes only in the relevant zone or for the appropriate user.

The regulation component 136 can use input from the voice recognition component 134 to determine the intent of a passenger’s speech. The regulation component 136 can analyze detected keywords or interpret natural language responses provided by a large language model to determine the appropriate action. The regulation component 136 can further modify a response based on vehicle status data, ensuring that the requested function is performed in a safe and appropriate manner.

The regulation component 136 can regulate vehicle systems in response to commands that involve complex or multi-step requests. The regulation component 136 can use data from the passenger identification component 130 to determine a relevant control zone and an appropriate seat adjustments based on passenger location. The regulation component 136 can use vehicle status data to determine whether certain actions should be permitted, restricted, or modified based on safety considerations.

The regulation component 136 can dynamically adapt vehicle settings in response to environmental conditions. The regulation component 136 can personalize vehicle settings based on stored user profiles. The regulation component 136 can manage media and communication functions to improve the in-car experience. The regulation component 136 can improve vehicle security by enforcing authorization requirements for certain commands. For example, if a child seated in the second row requests to unlock the doors while the vehicle is in motion, the regulation component 136 can reject the request unless the identified speaker is an authorized adult. Similarly, the regulation component 136 can require driver verification before enabling potentially dangerous commands, such as disabling driver assistance systems or altering safety settings. The regulation component 136 can also regulate vehicle systems in response to predictive modeling and learned behaviors. The regulation component 136 can also optimize responses by combining multiple data sources to provide contextually appropriate actions.

In some embodiments, the computer-executable components can include an artificial intelligence component. The artificial intelligence component 202 can train an artificial intelligence model to identify a passenger inside the vehicle.

The artificial intelligence component 202 can train an artificial intelligence system to identify one or more passengers inside the vehicle and can further train the AI system to determine in which seat each identified passenger is sitting. This functionality can be achieved through a combination of supervised learning, unsupervised learning, and reinforcement learning techniques. By continuously refining its recognition models through data collection and analysis, the artificial intelligence component 202 can improve the system’s accuracy, adaptability, and responsiveness over time. The artificial intelligence component 202 can train the AI system to identify passengers using a variety of data inputs. These data inputs can include voice data, visual data from occupant monitoring cameras, motion sensor data, and contextual information such as seating position and connected devices. The artificial intelligence component 202 can combine these data points to build comprehensive models that identify individual passengers with increased reliability. The artificial intelligence component 202 can improve identification accuracy by training the AI system to recognize voice signatures. The AI system can be trained to analyze key acoustic characteristics such as pitch, tone, speech rhythm, and vocal patterns to generate a unique voice signature for each passenger. By combining this voice data with seating position information obtained through distributed microphones, the artificial intelligence component 202 can train the AI system to accurately associate voice profiles with individual seating positions. The artificial intelligence component 202 can train the AI system to utilize visual data to improve passenger identification. For example, the system can analyze visual data from occupant monitoring cameras to identify distinguishing features such as facial structure, hair color, or clothing. The artificial intelligence component 202 can combine this visual data with voice analysis to improve passenger identification accuracy.

The artificial intelligence component 202 can train the AI system to identify passenger location within the vehicle. By analyzing latency differences and audio intensity from multiple microphones, the AI system can be trained to determine the exact seating position of a speaking passenger. The AI system can correlate audio latency patterns with seating positions, allowing it to develop increasingly accurate localization capabilities.

The artificial intelligence component 202 can incorporate adaptive learning techniques to continuously improve system accuracy. The artificial intelligence component 202 can analyze past interactions, passenger behavior patterns, and environmental conditions to refine its recognition models. The artificial intelligence component 202 can train the AI system to predict passenger identity based on behavioral patterns and environmental cues. The artificial intelligence component 202 can train the AI system to recognize familial or social relationships among passengers to improve contextual decision-making. The artificial intelligence component 202 can train the AI system to resolve ambiguous or conflicting data.

The artificial intelligence component 202 can further enhance system functionality by learning from user responses to previous system actions. For example, the artificial intelligence component 202 can analyze how users adjust vehicle settings following system-initiated actions and apply this information to improve future responses. If a passenger requests the system to lower a window, and the passenger subsequently adjusts the window height, the artificial intelligence component 202 can correlate the adjusted window height with relevant contextual data, such as vehicle speed, temperature, or noise levels. The artificial intelligence component 202 can use this information to proactively refine future responses, such as automatically lowering the window to a preferred height under similar conditions.

By learning from user corrections and adjustments, the artificial intelligence component 202 can continuously improve its ability to deliver personalized and contextually appropriate actions. This adaptive behavior can extend to other vehicle functions such as climate control, audio volume, or seat positioning. For instance, if a driver frequently raises the cabin temperature after the system increases it in response to a passenger’s request, the artificial intelligence component 202 can adjust its future temperature changes to better align with the driver's comfort preferences.

The artificial intelligence component 202 can also improve system security by training the AI system to recognize unauthorized or unknown individuals. If the system detects a voice signature or visual profile that does not match any stored profiles, the artificial intelligence component 202 can train the AI system to treat that individual as unverified. In such cases, the system can restrict access to certain vehicle functions or require additional authentication before executing certain commands.

The systems and/or devices are described herein with respect to interaction between one or more components. Such systems and/or components can include the components and/or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity but known by those of skill in the art.

One or more systems, devices, computer program products, and/or computer-implemented methods provided herein relate to automated overlay correction of steering angle with minimal driver interference. A system can include a processor that executes computer executable components stored in memory. The computer executable components can include passenger identification component that identifies an at least one passenger inside the vehicle and determines a location of the at least one passenger within the vehicle. The computer executable components can further comprise a status component that determines a current status of the vehicle. The computer executable components can further comprise a voice recognition component that identifies speech of the at least one passenger within the vehicle and analyzes the speech to determine an intent of the at least one passenger. The computer executable components can further comprise a regulation component that, based at least on the identity of the at least one passenger, the location of the at least one passenger, the current status of the vehicle, or the determined intent of the at least one passenger, regulates one or more systems of the vehicle.

Systems described herein can be coupled (e.g., communicatively, electrically, operatively, optically, inductively, acoustically, etc.) to one or more local or remote (e.g., external) systems, sources, and/or devices (e.g., electronic control systems (ECU), classical and/or quantum computing devices, communication devices, etc.). For example, system 100 (or other systems, controllers, processors, etc.) can be coupled (e.g., communicatively, electrically, operatively, optically, etc.) to one or more local or remote (e.g., external) systems, sources, and/or devices using a data cable (e.g., High-Definition Multimedia Interface (HDMI), recommended standard (RS), Ethernet cable, etc.) and/or one or more wired networks described below.

In some embodiments, systems herein can be coupled (e.g., communicatively, electrically, operatively, optically, inductively, acoustically, etc.) to one or more local or remote (e.g., external) systems, sources, and/or devices (e.g., electronic control units (ECU), classical and/or quantum computing devices, communication devices, etc.) via a network. In these embodiments, such a network can comprise one or more wired and/or wireless networks, including, but not limited to, a cellular network, a wide area network (WAN) (e.g., the Internet), and/or a local area network (LAN). For example, system 100 can communicate with one or more local or remote (e.g., external) systems, sources, and/or devices, for instance, computing devices using such a network, which can comprise virtually any desired wired or wireless technology, including but not limited to: powerline ethernet, VHF, UHF, AM, wireless fidelity (Wi-Fi), BLUETOOTH®, fiber optic communications, global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, Session Initiation Protocol (SIP), ZIGBEE®, RF4CE protocol, WirelessHART protocol, L-band voice or data information, 6LoWPAN (IPv6 over Low power Wireless Area Networks), Z-Wave, an ANT, an ultra-wideband (UWB) standard protocol, and/or other proprietary and non-proprietary communication protocols. In this example, system 100 can thus include hardware (e.g., a central processing unit (CPU), a transceiver, a decoder, an antenna (e.g., a ultra-wideband (UWB) antenna, a BLUETOOTH® low energy (BLE) antenna, etc.), quantum hardware, a quantum processor, etc.), software (e.g., a set of threads, a set of processes, software in execution, quantum pulse schedule, quantum circuit, quantum gates, etc.), or a combination of hardware and software that facilitates communicating information between a system herein and remote (e.g., external) systems, sources, and/or devices (e.g., computing and/or communication devices such as, for instance, a smart phone, a smart watch, wireless earbuds, etc.).

Systems herein can comprise one or more computer and/or machine readable, writable, and/or executable components and/or instructions that, when executed by processor (e.g., a processing unit 110 which can comprise a classical processor, a quantum processor, etc.), can facilitate performance of operations defined by such component(s) and/or instruction(s). Further, in numerous embodiments, any component associated with a system herein, as described herein with or without reference to the various figures of the subject disclosure, can comprise one or more computer and/or machine readable, writable, and/or executable components and/or instructions that, when executed by a processor, can facilitate performance of operations defined by such component(s) and/or instruction(s). Consequently, according to numerous embodiments, system herein and/or any components associated therewith as disclosed herein, can employ a processor (e.g., processing unit 110) to execute such computer and/or machine readable, writable, and/or executable component(s) and/or instruction(s) to facilitate performance of one or more operations described herein with reference to system herein and/or any such components associated therewith.

Systems herein can comprise any type of system, device, machine, apparatus, component, and/or instrument that comprises a processor and/or that can communicate with one or more local or remote electronic systems and/or one or more local or remote devices via a wired and/or wireless network. All such embodiments are envisioned. For example, a system (e.g., a system 100 or any other system or device described herein) can comprise a computing device, a general-purpose computer, field-programmable gate array, AI accelerator application-specific integrated circuit, a special-purpose computer, an onboard computing device, a communication device, an onboard communication device, a server device, a quantum computing device (e.g., a quantum computer), a tablet computing device, a handheld device, a server class computing machine and/or database, a laptop computer, a notebook computer, a desktop computer, wearable device, internet of things device, a cell phone, a smart phone, a consumer appliance and/or instrumentation, an industrial and/or commercial device, a digital assistant, a multimedia Internet enabled phone, a multimedia players, and/or another type of device.

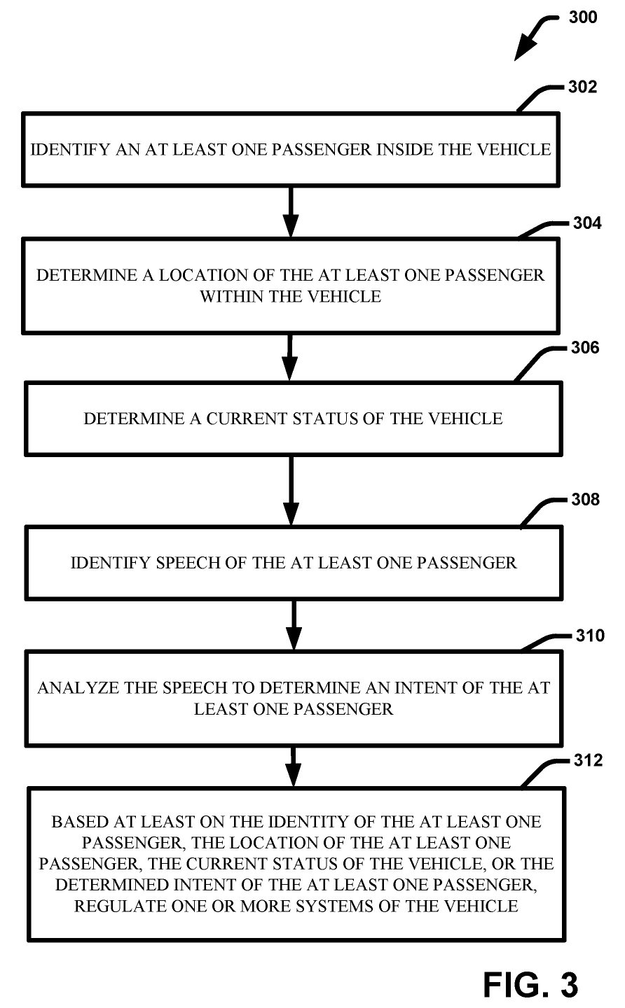

Next, FIG. 3 illustrates a flow diagram of a method 300 that can facilitate dynamic voice assistance for transportation vehicles in accordance with some embodiments described herein, such as the system 200 of FIG. 2 and the system 100 of FIG. 1.

For simplicity of explanation, the computer-implemented methods provided herein are depicted and/or described as a series of actions. It is to be understood that the subject matter is not limited by the actions illustrated and/or by the order thereof. For example, actions can occur in one or more orders, concurrently, and/or with other acts not presented and described herein. Furthermore, not all illustrated actions can be utilized to implement the computer-implemented methods in accordance with the described subject matter. In addition, the computer-implemented methods could alternatively be represented as a series of interrelated states via a state diagram or events. Additionally, the computer-implemented methods described in this specification are capable of being stored on an article of manufacture to facilitate transporting and transferring the computer-implemented methods to computers. The term article of manufacture, as used herein, encompasses a computer program accessible from any computer-readable device or storage media.

While the method 300 is described relative to the system 200 of FIG. 2, the method 300 can be applicable also to other systems described herein. Repetitive description of like elements and/or processes employed in respective embodiments is omitted for sake of brevity.

At 302, the method can include an at least one passenger inside a vehicle. This identification process can involve multiple data sources, including audio data, visual data, and contextual information, to accurately recognize and distinguish between passengers. The identification process can improve system functionality by enabling personalized responses, targeted control of vehicle systems, and improved communication between passengers and the vehicle's voice assistant. The identification process at 302 can begin with the detection of passenger presence. This detection can be achieved using sensors installed throughout the vehicle. Alternatively, the system can utilize door sensors to determine when a passenger has entered or exited the vehicle. These sensors can provide initial data points that indicate the presence of one or more passengers inside the vehicle. In addition to physical sensors, the identification process at 302 can involve the detection of voice data. The system can employ multiple microphones distributed throughout the vehicle’s interior to capture speech signals. These microphones can include acoustic echo cancellation technology to isolate voice signals from background noise, improving the accuracy of passenger detection in noisy environments. The system can also apply Voice Activity Detection to determine when a passenger is actively speaking. VAD can assign probability scores to short audio samples, helping the system distinguish between speech and background noise. The identification process at 302 can further involve the use of visual data captured by occupant monitoring cameras, driver monitoring cameras, or exterior cameras. These cameras can analyze facial features, body posture, or movement patterns to detect passenger presence. Visual data can also provide information about the number of passengers present, their approximate size or age, and their orientation within the vehicle. For example, exterior cameras can be used to identify an approaching user before the user ever enters the vehicle. Users can be identified by analyzing posture, walking style, body dimensions , number of users approaching the car or any other identifying traits captured via a visual sensor. Once the system detects the presence of one or more passengers, the identification process at 302 can proceed to determine the identity of each passenger. The system can reference a database of known voice signatures, facial profiles, or user profiles to attempt to match the detected passenger to a stored identity. To improve identification accuracy, the system can combine multiple data sources during the identification process at 302. For example, the system can compare detected voice signatures with Bluetooth device connectivity data to increase the probability of a correct identification. The identification process at 302 can also involve dynamically refining passenger profiles to improve future identification accuracy. In some embodiments, the identification process at 302 can involve relationship-based inference to improve identification outcomes. The identification process at 302 can also support enhanced security features. The identification process at 302 can further improve communication efficiency by associating detected passengers with their seating positions.

At 304, the method can include determining a location of the at least one passenger within the vehicle. This functionality can involve analyzing data from multiple sources, including audio signals, visual data, sensor inputs, and contextual information to accurately determine the seating position of one or more passengers. The determination of passenger location at 304 can be achieved using an array of distributed microphones installed throughout the vehicle's cabin. These microphones can capture speech signals from various seating zones. By analyzing the latency between microphones and the decibel (dB) levels of the detected audio, the system can calculate the relative position of the speaking passenger. The system can further improve location detection accuracy by applying Time Difference of Arrival (TDOA) techniques. TDOA can involve measuring the time delay between when a speech signal is detected by multiple microphones. By calculating these time differences, the system can determine the spatial origin of the sound. In addition to microphone-based detection, the system can incorporate visual sensors such as occupant monitoring cameras or driver monitoring cameras to determine passenger location. These cameras can detect the presence, position, and movement of passengers within the vehicle. The system can further refine passenger location data by incorporating seat sensor data. Pressure sensors or weight sensors embedded in vehicle seats can provide information about which seats are occupied. The system can combine multiple data points to increase the reliability of passenger location detection. In some embodiments, the system can leverage Bluetooth or mobile device connectivity to help determine passenger location. The determination of passenger location at 304 can also involve dynamic adjustments based on environmental conditions and system feedback.

At 306, the method can include determining a current status of the vehicle. Act 306 can include analyzing data from multiple sources, such as internal vehicle sensors, environmental sensors, and external data feeds, to accurately assess the vehicle’s operating conditions. The status determination at 306 can include identifying whether the vehicle is driving, parked, or idling. The system can analyze vehicle speed, acceleration, and gear position data to assess these conditions. The status determination can also include detecting environmental conditions such as rain, snow, or fog by referencing data from windshield wipers, traction control systems, and external temperature sensors. Additionally, the system can determine if the vehicle is in a construction zone, near emergency vehicles, or experiencing hazardous road conditions by utilizing GPS data, real-time traffic information, or vehicle-to-infrastructure communication. The system can also determine if the vehicle has been in an accident by referencing collision detection sensors, airbag deployment data, or diagnostic error codes. In some embodiments, the system can identify mechanical issues, such as low tire pressure or engine overheating, and adjust system responses accordingly. The determination of vehicle status at 306 can include continuously monitoring vehicle behavior and environmental factors to improve accuracy and responsiveness.

At 308, the method can include identifying speech of at least one passenger. This can include capturing, processing, and analyzing audio data from one or more microphones positioned throughout the vehicle’s cabin. The system can utilize acoustic echo cancellation microphones to isolate speech from background noise such as music, road noise, or other conversations. The system can apply VAD techniques to distinguish speech from non-speech sounds by assigning probability scores to detected audio segments. The system can use beamforming techniques to focus on sound originating from a particular direction. Act 308 can include separating simultaneous conversations by isolating distinct voice sources to ensure accurate detection.

At 310, the method can include analyzing the speech to determine both the identity and the intent of the passenger. The system can analyze features such as pitch, tone, cadence, accent, and speech patterns to generate a voice signature that uniquely represents the speaker. The system can reference the voice signature against a database of known voice profiles to determine the speaker’s identity. Each comparison can include a probability score indicating the system’s confidence in the match. If the probability score meets or exceeds a predefined threshold, the system can confirm the passenger’s identity.

In addition to determining identity, the system can analyze the content and structure of the detected speech to determine the passenger’s intent. This intent analysis can involve identifying specific keywords, contextual cues, and linguistic patterns that indicate what action the passenger wants the system to perform. For example, if the detected speech includes phrases such as “I’m cold” or “Turn down the heat,” the system can interpret this as a request to adjust the vehicle’s climate settings. The system can combine this intent analysis with contextual information, such as seating position, recent interactions, or connected mobile devices, to tailor its response accordingly.

In some embodiments, the system can dynamically refine its intent recognition models by analyzing user corrections and behavioral patterns over time. For example, if a passenger consistently requests to “lower the window a little” after the system performs a full window adjustment, the system can learn to modify its future responses to better align with the user’s preferences.

At 312, the method can include regulating one or more systems of the vehicle. The regulating can be based at least on the identity of the at least one passenger, the location of the at least one passenger, the current status of the vehicle, or the determined intent of the at least one passenger. The system can regulate various in-vehicle features such as climate control, audio output, lighting, seat positioning, navigation, and infotainment settings. The system can also restrict or modify certain functions based on vehicle status. In some embodiments, the system can reference user profiles to apply personalized settings or preferences automatically. The system can further prioritize critical requests, such as navigation updates or safety alerts, when vehicle conditions indicate a heightened need for focus.

In some embodiments, method 300 is performed by a system, such as system 100 of FIG. 1 or system 200 of FIG. 2.

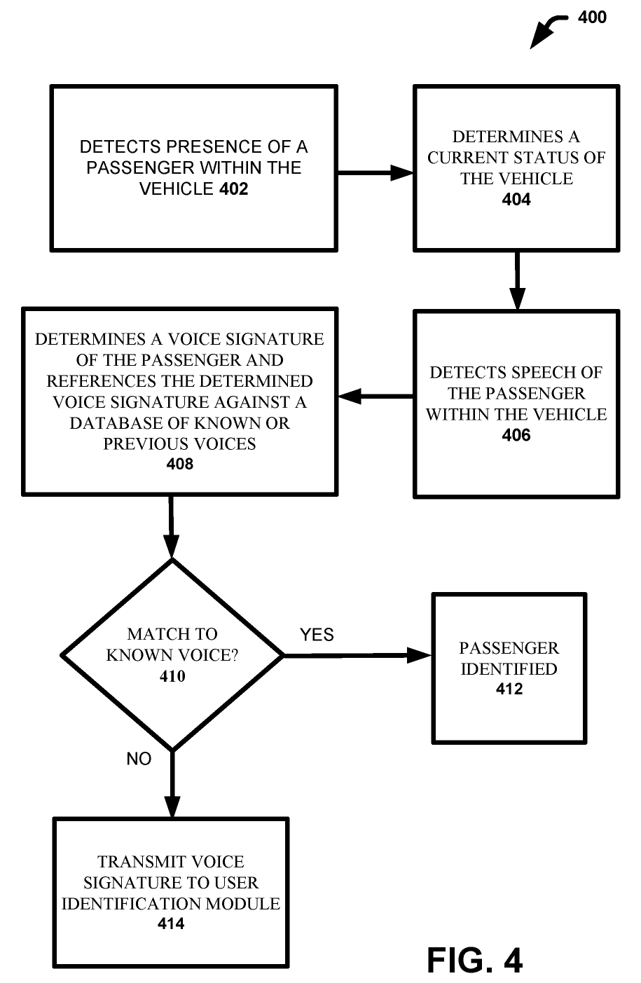

Next, FIG. 4 illustrates a flow diagram of a method 400 that can facilitate dynamic voice assistance for transportation vehicles in accordance with some embodiments described herein, such as the system 200 of FIG. 2 and the system 100 of FIG. 1. While the method 400 is described relative to the system 200 of FIG. 2, the method 400 can be applicable also to other systems described herein. Repetitive description of like elements and/or processes employed in respective embodiments is omitted for sake of brevity.

At 402, the method can include detecting a presence of a passenger within a vehicle. At 404, the method can include determining a current status of the vehicle. At 406, the method can include detecting speech of the passenger. At 408, the method can include determining a voice signature of the passenger and referencing the voice signature against a database of known or previous voices. The system can analyze various characteristics of the speech, such as pitch, tone, cadence, vocal tract characteristics, and speech patterns, to create a digital representation of the passenger’s voice. This voice signature can serve as a biometric identifier to distinguish between different passengers based on vocal traits. Once the voice signature is determined, the system can reference the signature against a database of stored voice profiles. This database can contain voice profiles associated with known passengers, including frequent vehicle occupants and registered users. Each voice profile in the database can include identifying information such as user preferences, seating habits, or access permissions. At 410, the method can include determining whether the voice signature matches a known or previous voice from the database. The system can compare the determined voice signature to these stored profiles and calculate a probability score that reflects the system’s confidence in the identity match. If the probability score meets or exceeds a predetermined threshold, the system can confirm the speaker’s identity at 412. In some embodiments, if the system is unable to confidently match the voice signature to a stored profile, the method can proceed to 414, which can include transmitting the signature to a user identification module for further analysis. The system can combine the voice signature data with contextual information (e.g., seating position, connected devices, or recent interactions) to improve identification accuracy. Act 414 can include updating the database by refining existing profiles or creating new profiles based on newly captured voice data.

In various embodiments, the method 400 can include learning a user’s voice signature and/or sensor information and updating a database of known users or user profiles with the learned information.

In some embodiments, method 400 is performed by a system, such as system 100 of FIG. 1 or system 200 of FIG. 2.

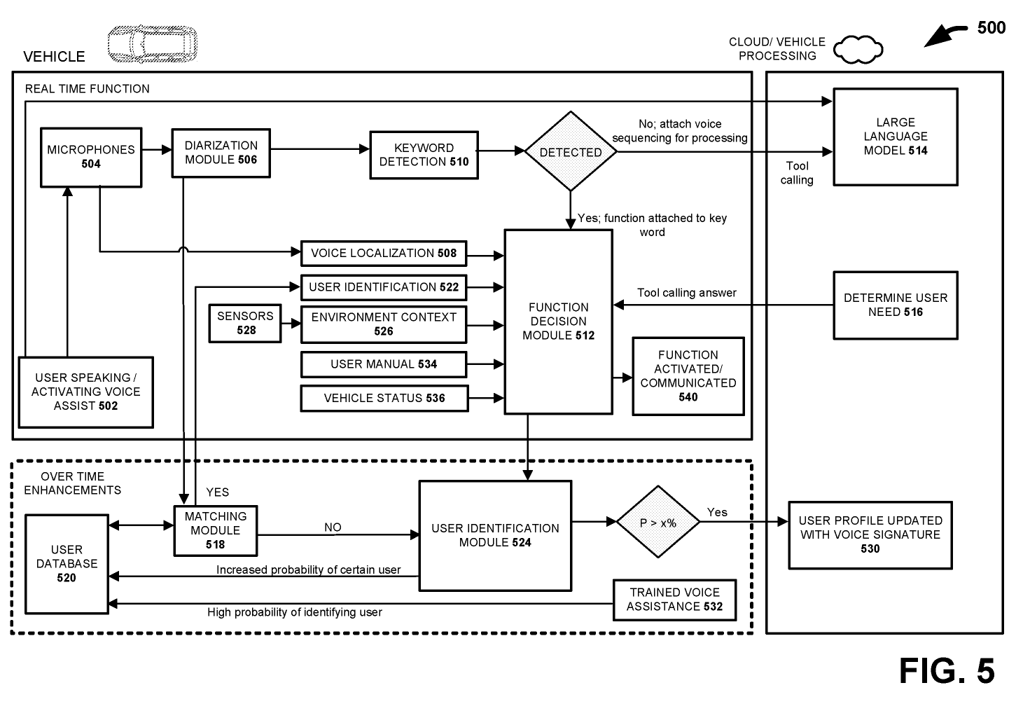

Next, FIG. 5 illustrates a diagram of an example system architecture 500 that can facilitate dynamic voice assistance for transportation vehicles in accordance with some embodiments described herein. Repetitive description of like elements and/or processes employed in respective embodiments is omitted for sake of brevity.

A system 500 for smart voice assistance can be installed in a vehicle. The smart voice assistance system can also have capabilities in the cloud. When a user (driver or any passenger) in the vehicle is speaking (502), several acoustic echo cancellation microphones in the vehicle can pick up the sound (504). These microphones can include, for example, XMOS microphones with onboard digital processing that can remove noise, filter out unwanted sounds, and enhance the detected voice. These types of microphones can filter out speech from a sound-contaminated environment where, for example, music is playing. This process can be referred to as Voice Activity Detection (VAD), which can take place in the Diarization Module (506).

Voice Activity Detection can involve assigning a probability percentage to indicate the likelihood that speech is present in a given audio sample. For example, from a 1-minute recording, the system 500 can divide the data into 200ms samples, and each sample can have an associated probability score indicating the likelihood that someone is speaking. This process can enable the system 500 to answer the question “who spoke when” without prior knowledge of the speakers and, depending on the application, without prior knowledge of the number of speakers.

Microphones can be distributed throughout the vehicle. The system 500 can identify the location of detected voice (508). Determining the location can involve processing the detected sound signal to determine which microphone first captured the voice. This can be achieved by measuring latency differences between the microphones and analyzing the decibel (dB) level of the detected audio.

The voice message captured by the microphones can be analyzed for keywords using a Keyword Spotting Module (510). If the detected keywords are associated with a function, they can be transmitted to the Function Decision Module (512) for further processing. If no relevant keywords are detected, the entire speech string can be sent to a Large Language Model (LLM) (514) through Tool Calling for interpretation. The LLM can be executed onboard the vehicle or in the cloud. The system 500 can also allow the user (502) to activate voice assistant recording for LLM processing directly by pressing a dedicated button or issuing an activation statement. The LLM can analyze the speech data, interpret the user’s intent, and provide a corresponding response. For example, if the user says, “I’m cold,” the Tool Calling response can include information that indicates the user wishes to increase the cabin temperature. This interpreted response can then be sent to the Function Decision Module (512) for processing and action.

When Voice Activity Detection is performed (506), the speech information can also be transmitted to a Matching Module (518), which can analyze the detected voice signature and compare it against a database (520) of previously stored voices. This database can include profiles of users who have been active in the vehicle before or are stored as part of designated user profiles. Each stored voice signature can include a probability score ranging from 0 to 100% that reflects the system’s confidence in matching the detected voice signature to a specific individual. If the probability score meets or exceeds a predefined threshold, the system 500 can regard the speaker as identified (522) and transmit this information back to the Function Decision Module (512).

If the system fails to match the detected voice signature to any stored profiles in the database, the voice signature can be transmitted to a User Identification Module (524) for further analysis. The User Identification Module can use additional contextual information to improve the identification probability. For example, if there is only one person in the vehicle, and that individual is logged in with a user profile and has a connected mobile phone, the system can reasonably infer that the individual’s voice signature matches the connected profile. This inference can be fed back into the database to increase the probability of correctly identifying the individual in future interactions.

The system 500 can also incorporate data from environmental sensors, as illustrated by the Environment Context Module (526). For example, by utilizing sensors (528) located inside and outside the vehicle, the system can connect the detected voice signature to a face signature captured by the driver monitoring cameras or occupant monitoring cameras. This additional layer of identification data can further improve the system’s ability to accurately connect a detected voice signature to a specific individual. When a voice signature is identified with a sufficient degree of confidence, the system can link the signature to a User Profile (530) stored in the cloud. This stored profile data can then be accessed in any compatible vehicle to identify the user by their voice profile.

Voice signature identification can also be improved through deliberate training of the system (532), which can occur as part of an onboarding process. During this training, the system can refine its ability to recognize individual voice profiles more effectively.

The Function Decision Module (512) can also incorporate information from the User Manual (534) and Car Status Module (536). Car status data can include parameters such as vehicle speed, acceleration, navigation destination, and other operational details. The Function Decision Module can utilize these combined data points to determine what action to take in response to a detected command.

The final step of the procedure can involve the Function Decision Module deciding what action to perform or what information to communicate based on input from keyword detection, Tool Calling analysis, speaker localization, speaker identity, environmental data, the user manual, and vehicle status information.

The User Identification Module (524) can operate continuously in the background, gathering data about voice signatures and passenger identities. The User Identification Module can also establish relationships between users to improve contextual awareness. For example, if a child in the vehicle says, “Dad, when will we arrive?” and a male voice responds from the driver’s seat, the system can infer that the driver is the father of the child and store this information in the database. This relationship data can further improve the accuracy of decisions made by the Function Decision Module (512). The database can be implemented as a graph database, allowing efficient storage and management of interconnected data points for improved decision-making and personalization.

In order to provide additional context for various embodiments described herein, FIG. 6 and the following discussion are intended to provide a brief, general description of a suitable computing environment 600 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers (e.g., ruggedized personal computers), field-programmable gate arrays, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, optic, infrared, and other wireless media.

With reference again to FIG. 6, the example environment 600 for implementing various embodiments of the aspects described herein includes a computer 602, the computer 602 including a processing unit 604, a system memory 606 and a system bus 608. The system bus 608 couples system components including, but not limited to, the system memory 606 to the processing unit 604. The processing unit 604 can be any of various commercially available processors, field-programmable gate array, AI accelerator application-specific integrated circuit, or other suitable processors. Dual microprocessors and other multi-processor architectures can also be employed as the processing unit 604.

The system bus 608 can be any of several types of bus structure that can further interconnect to a memory bus (with or without a memory controller), a peripheral bus, and a local bus using any of a variety of commercially available bus architectures. The system memory 606 includes ROM 610 and RAM 612. A basic input/output system (BIOS) can be stored in a non-volatile memory such as ROM, erasable programmable read only memory (EPROM), EEPROM, which BIOS contains the basic routines that help to transfer information between elements within the computer 602, such as during startup. The RAM 612 can also include a high-speed RAM such as static RAM for caching data. It is noted that unified Extensible Firmware Interface(s) can be utilized herein.

The computer 602 further includes an internal hard disk drive (HDD) 614 (e.g., EIDE, SATA), one or more external storage devices 616 (e.g., a magnetic floppy disk drive (FDD) 616, a memory stick or flash drive reader, a memory card reader, etc.) and an optical disk drive 620 (e.g., which can read or write from a disc 622 such as a CD-ROM disc, a DVD, a BD, etc.). While the internal HDD 614 is illustrated as located within the computer 602, the internal HDD 614 can also be configured for external use in a suitable chassis (not shown). Additionally, while not shown in environment 600, a solid-state drive (SSD) could be used in addition to, or in place of, an HDD 614. The HDD 614, external storage device(s) 616 and optical disk drive 620 can be connected to the system bus 608 by an HDD interface 624, an external storage interface 626 and an optical drive interface 628, respectively. The interface 624 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 602, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 612, including an operating system 630, one or more application programs 632, other program modules 634 and program data 636. All or portions of the operating system, applications, modules, and/or data can also be cached in the RAM 612. The systems and methods described herein can be implemented utilizing various commercially available operating systems or combinations of operating systems.

Computer 602 can optionally comprise emulation technologies. For example, a hypervisor (not shown) or other intermediary can emulate a hardware environment for operating system 630, and the emulated hardware can optionally be different from the hardware illustrated in FIG. 6. In such an embodiment, operating system 630 can comprise one virtual machine (VM) of multiple VMs hosted at computer 602. Furthermore, operating system 630 can provide runtime environments, such as the Java runtime environment or the .NET framework, for applications 632. Runtime environments are consistent execution environments that allow applications 632 to run on any operating system that includes the runtime environment. Similarly, operating system 630 can support containers, and applications 632 can be in the form of containers, which are lightweight, standalone, executable packages of software that include, e.g., code, runtime, system tools, system libraries and settings for an application.

Further, computer 602 can be enabled with a security module, such as a trusted processing module (TPM). For instance, with a TPM, boot components hash next in time boot components, and wait for a match of results to secured values, before loading a next boot component. This process can take place at any layer in the code execution stack of computer 602, e.g., applied at the application execution level or at the operating system (OS) kernel level, thereby enabling security at any level of code execution.

A user can enter commands and information into the computer 602 through one or more wired/wireless input devices, e.g., a keyboard 638, a touch screen 640, and a pointing device, such as a mouse 642. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 604 through an input device interface 644 that can be coupled to the system bus 608, but can be connected by other interfaces, such as a parallel port, an IEEE 1394 serial port, a game port, a USB port, an IR interface, a BLUETOOTH® interface, etc.

A monitor 646 or other type of display device can also be connected to the system bus 608 via an interface, such as a video adapter 648. In addition to the monitor 646, a computer typically includes other peripheral output devices (not shown), such as speakers, printers, etc.

The computer 602 can operate in a networked environment using logical connections via wired and/or wireless communications to one or more remote computers, such as a remote computer(s) 650. The remote computer(s) 650 can be a workstation, a server computer, a router, a personal computer, portable computer, microprocessor-based entertainment appliance, a peer device or other common network node, and typically includes many or all of the elements described relative to the computer 602, although, for purposes of brevity, only a memory/storage device 652 is illustrated. The logical connections depicted include wired/wireless connectivity to a local area network (LAN) 654 and/or larger networks, e.g., a wide area network (WAN) 656. Such LAN and WAN networking environments are commonplace in offices and companies, and facilitate enterprise-wide computer networks, such as intranets, all of which can connect to a global communications network, e.g., the Internet.

When used in a LAN networking environment, the computer 602 can be connected to the local network 654 through a wired and/or wireless communication network interface or adapter 658. The adapter 658 can facilitate wired or wireless communication to the LAN 654, which can also include a wireless access point (AP) disposed thereon for communicating with the adapter 658 in a wireless mode.

When used in a WAN networking environment, the computer 602 can include a modem 660 or can be connected to a communications server on the WAN 656 via other means for establishing communications over the WAN 656, such as by way of the Internet. The modem 660, which can be internal or external and a wired or wireless device, can be connected to the system bus 608 via the input device interface 644. In a networked environment, program modules depicted relative to the computer 602 or portions thereof, can be stored in the remote memory/storage device 652. It will be appreciated that the network connections shown are example and other means of establishing a communications link between the computers can be used.

When used in either a LAN or WAN networking environment, the computer 602 can access cloud storage systems or other network-based storage systems in addition to, or in place of, external storage devices 616 as described above. Generally, a connection between the computer 602 and a cloud storage system can be established over a LAN 654 or WAN 656 e.g., by the adapter 658 or modem 660, respectively. Upon connecting the computer 602 to an associated cloud storage system, the external storage interface 626 can, with the aid of the adapter 658 and/or modem 660, manage storage provided by the cloud storage system as it would other types of external storage. For instance, the external storage interface 626 can be configured to provide access to cloud storage sources as if those sources were physically connected to the computer 602.

The computer 602 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

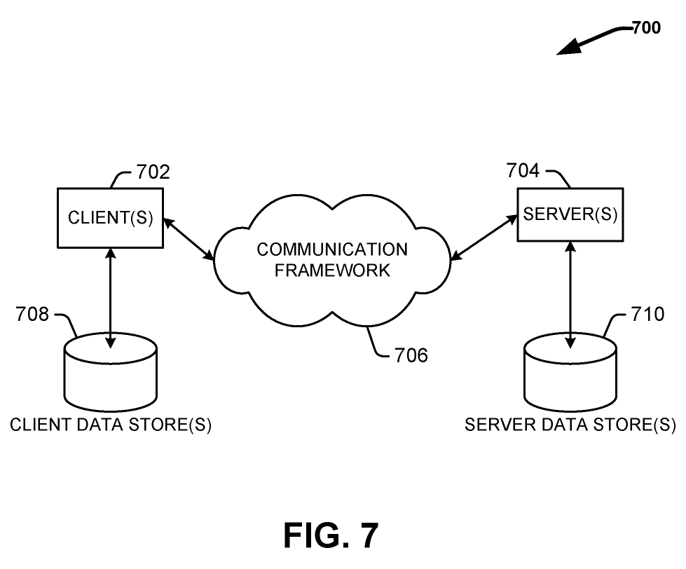

Referring now to FIG. 7, there is illustrated a schematic block diagram of a computing environment 700 in accordance with this specification. The system 700 includes one or more client(s) 702, (e.g., computers, smart phones, tablets, cameras, PDA’s). The client(s) 702 can be hardware and/or software (e.g., threads, processes, computing devices). The client(s) 702 can house cookie(s) and/or associated contextual information by employing the specification, for example.

The system 700 also includes one or more server(s) 704. The server(s) 704 can also be hardware or hardware in combination with software (e.g., threads, processes, computing devices). The servers 704 can house threads to perform transformations of media items by employing aspects of this disclosure, for example. One possible communication between a client 702 and a server 704 can be in the form of a data packet adapted to be transmitted between two or more computer processes wherein data packets can include coded analyzed headspaces and/or input. The data packet can include a cookie and/or associated contextual information, for example. The system 700 includes a communication framework 706 (e.g., a global communication network such as the Internet) that can be employed to facilitate communications between the client(s) 702 and the server(s) 704.

Communications can be facilitated via a wired (including optical fiber) and/or wireless technology. The client(s) 702 are operatively connected to one or more client data store(s) 708 that can be employed to store information local to the client(s) 702 (e.g., cookie(s) and/or associated contextual information). Similarly, the server(s) 704 are operatively connected to one or more server data store(s) 710 that can be employed to store information local to the servers 704. Further, the client(s) 702 can be operatively connected to one or more server data store(s) 710.

In one exemplary implementation, a client 702 can transfer an encoded file, (e.g., encoded media item), to server 704. Server 704 can store the file, decode the file, or transmit the file to another client 702. It is noted that a client 702 can also transfer uncompressed file to a server 704 and server 704 can compress the file and/or transform the file in accordance with this disclosure. Likewise, server 704 can encode information and transmit the information via communication framework 706 to one or more clients 702.

The illustrated aspects of the disclosure can also be practiced in distributed computing environments where certain tasks are performed by remote processing devices that are linked through a communications network. In a distributed computing environment, program modules can be located in both local and remote memory storage devices.

The above description includes non-limiting examples of the various embodiments. It is, of course, not possible to describe every conceivable combination of components or methods for purposes of describing the disclosed subject matter, and one skilled in the art can recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter can have been disclosed with respect to only one of several implementations, such feature can be combined with one or more other features of the other implementations as can be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive - in a manner similar to the term “comprising” as an open transition word - without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

Further aspects of the invention are provided by the subject matter of the following clauses:
1. A system onboard a vehicle, comprising: a memory that stores computer executable components; and a processor that executes the computer executable components stored in memory, wherein the computer executable components comprise: a passenger identification component that identifies an at least one passenger inside the vehicle and determines a location of the at least one passenger within the vehicle; a status component that determines a current status of the vehicle; a voice recognition component that identifies speech of the at least one passenger within the vehicle and analyzes the speech to determine an intent of the at least one passenger; a regulation component that, based at least on the identity of the at least one passenger, the location of the at least one passenger, the current status of the vehicle, or the determined intent of the at least one passenger, regulates one or more systems of the vehicle.
2. The system of any one or more preceding clause(s),, wherein the passenger identification component uses microphones to detect speech of the at least one passenger.
3. The system of any one or more preceding clause(s), wherein the passenger identification component measures latency between the microphones and a decibel level of the detected speech to determine the location of the at least one passenger within the vehicle.
4. The system of any one or more preceding clause(s),, wherein the passenger identification determines a voice signature of the at least one passenger based on the detected speech and references the determined voice signature against a database of known or previous voices to identify the at least one passenger.
5. The system of any one or more preceding clause(s), wherein the passenger identification component updates a probability score associated with the voice signature in the database based on historical interactions, user profiles, or device connections.
6. The system of any one or more preceding clause(s), wherein the passenger identification component fails to match a voice signature to a stored profile and transmits the voice signature to a user identification module for further processing.
7. The system of any one or more preceding clause(s), wherein the passenger identification component uses visual sensors to identify the passenger or determine in which seat the passenger is sitting.
8. The system of any one or more preceding clause(s), wherein the voice recognition component further comprises a key word spotting module that detects specific key words in the detected speech, determines the detected key words are associated with a function, and transmits the key words to a function decision module for further processing.
9. The system of any one or more preceding clause(s), wherein the voice recognition component transmits speech data to a large language model for analysis and interpretation of the passenger’s intent.
10. The system of any one or more preceding clause(s), wherein the passenger identification component determines an identity of a passenger based on voice signature analysis, mobile device connectivity, or user profile information.
11. The system of any one or more preceding clause(s), further comprising an artificial intelligence component that trains an artificial intelligence system to identify a passenger inside the vehicle.
12. The system of any one or more preceding clause(s), wherein the artificial intelligence component trains the artificial intelligence system to determine in which seat the passenger is sitting.
13. The system of any one or more preceding clause(s), the passenger identification component determines that a passenger has exited the vehicle.
14. The system of any one or more preceding clause(s), wherein the passenger identification component determines that a passenger has entered the vehicle.
15. The system of any one or more preceding clause(s), wherein the passenger identification component determines that a passenger has changed seats.
16. A computer-implemented method performed by a data processing device of a vehicle, comprising: identifying an at least one passenger inside the vehicle; determining a location of the at least one passenger within the vehicle; determining a current status of the vehicle; identifying speech of the at least one passenger; analyzing the speech to determine an intent of the at least one passenger; and, based at least on the identity of the at least one passenger, the location of the at least one passenger, the current status of the vehicle, or the determined intent of the at least one passenger, regulating one or more systems of the vehicle.
17. The computer-implemented method of any one or more preceding clause(s), further comprising using microphones to identify the speech of the passenger.
18. The computer-implemented method of any one or more preceding clause(s), further comprising measuring latency between the microphones and a decibel level of the detected speech to determine the location of the passenger within the vehicle.
19. The computer-implemented method of any one or more preceding clause(s), further comprising determining a voice signature of a passenger based on the detected speech and referencing the determined voice signature against a database of known or previous voices to identify the passenger.
20. A non-transitory machine-readable storage medium, comprising executable instructions that, when executed by a processor onboard a vehicle, facilitate performance of operations, comprising: identifying an at least one passenger inside the vehicle; determining a location of the at least one passenger; determining a current status of the vehicle; identifying speech of the at least one passenger within the vehicle; analyzing the speech to determine an intent of the at least one passenger; and, based at least on the identity of the at least one passenger, the location of the at least one passenger, the current status of the vehicle, or the determined intent of the at least one passenger, regulating one or more systems of the vehicle.
21. Any suitable combination of any one or more of system clauses 1-16.
22. Any suitable combination of any one of more of method clause 17-19.
23. Any suitable combination of any one or more of clauses 1-20.

What is claimed is:

1. A system onboard a vehicle, comprising:
a memory that stores computer executable components; and
a processor that executes the computer executable components stored in memory, wherein the computer executable components comprise:
a passenger identification component that identifies an at least one passenger inside the vehicle and determines a location of the at least one passenger within the vehicle;
a status component that determines a current status of the vehicle;
a voice recognition component that identifies speech of the at least one passenger within the vehicle and analyzes the speech to determine an intent of the at least one passenger;
a regulation component that, based at least on the identity of the at least one passenger, the location of the at least one passenger, the current status of the vehicle, or the determined intent of the at least one passenger, regulates one or more systems of the vehicle.

2. The system of claim 1, wherein the passenger identification component uses microphones to detect speech of the at least one passenger.

3. The system of claim 2, wherein the passenger identification component measures latency between the microphones and a decibel level of the detected speech to determine the location of the at least one passenger within the vehicle.

4. The system of claim 2, wherein the passenger identification determines a voice signature of the at least one passenger based on the detected speech and references the determined voice signature against a database of known or previous voices to identify the at least one passenger.

5. The system of claim 4, wherein the passenger identification component updates a probability score associated with the voice signature in the database based on historical interactions, user profiles, or device connections.

6. The system of claim 4, wherein the passenger identification component fails to match a voice signature to a stored profile and transmits the voice signature to a user identification module for further processing.

7. The system of claim 1, wherein the passenger identification component uses visual sensors to identify the passenger or determine in which seat the passenger is sitting.

8. The system of claim 1, wherein the voice recognition component further comprises a key word spotting module that detects specific key words in the detected speech, determines the detected key words are associated with a function, and transmits the key words to a function decision module for further processing.

9. The system of claim 1, wherein the voice recognition component transmits speech data to a large language model for analysis and interpretation of the passenger’s intent.

10. The system of claim 1, wherein the passenger identification component determines an identity of a passenger based on voice signature analysis, mobile device connectivity, or user profile information.

11. The system of claim 1, further comprising an artificial intelligence component that trains an artificial intelligence system to identify a passenger inside the vehicle.

12. The system of claim 11, wherein the artificial intelligence component trains the artificial intelligence system to determine in which seat the passenger is sitting.

13. The system of claim 1, wherein the passenger identification component determines that a passenger has exited the vehicle.

14. The system of claim 1, wherein the passenger identification component determines that a passenger has entered the vehicle.

15. The system of claim 1, wherein the passenger identification component determines that a passenger has changed seats.

16. A computer-implemented method performed by a data processing device of a vehicle, comprising:
identifying an at least one passenger inside the vehicle;
determining a location of the at least one passenger within the vehicle;
determining a current status of the vehicle;
identifying speech of the at least one passenger;
analyzing the speech to determine an intent of the at least one passenger; and
based at least on the identity of the at least one passenger, the location of the at least one passenger, the current status of the vehicle, or the determined intent of the at least one passenger, regulating one or more systems of the vehicle.

17. The computer-implemented method of claim 16, further comprising using microphones to identify the speech of the passenger.

18. The computer-implemented method of claim 17, further comprising measuring latency between the microphones and a decibel level of the detected speech to determine the location of the passenger within the vehicle.

19. The computer-implemented method of claim 17, further comprising determining a voice signature of a passenger based on the detected speech and referencing the determined voice signature against a database of known or previous voices to identify the passenger.

20. A non-transitory machine-readable storage medium, comprising executable instructions that, when executed by a processor onboard a vehicle, facilitate performance of operations, comprising:
identifying an at least one passenger inside the vehicle;
determining a location of the at least one passenger;
determining a current status of the vehicle;
identifying speech of the at least one passenger within the vehicle;
analyzing the speech to determine an intent of the at least one passenger; and
based at least on the identity of the at least one passenger, the location of the at least one passenger, the current status of the vehicle, or the determined intent of the at least one passenger, regulating one or more systems of the vehicle.
